(19) United States
(12) Patent Application Publication
(10) Pub. No.: US 2016/0342215 A1
(43) Pub. Date: Nov. 24, 2016

(54) INPUT APPARATUS

(71) Applicant: FUJITSU LIMITED, Kawasaki-shi (JP)

(72) Inventors: Yasuhiro ENDO, Ebina (JP); Yuichi KAMATA, Isehara (JP); Akinori MIYAMOTO, Sagamihara (JP); Kiyoshi TANINAKA, Ebina (JP)

(73) Assignee: FUJITSU LIMITED, Kawasaki-shi (JP)

(21) Appl. No.: 15/230,011

(22) Filed: Aug. 5, 2016

Related U.S. Application Data
(63) Continuation of application No. PCT/JP2014/053445, filed on Feb. 14, 2014.

(51) Int. Cl. G06F 3/01; G06F 3/045; G06F 3/044

(52) U.S. Cl. CPC G06F 3/016; G06F 3/044; G06F 3/045; G06F 2203/014

(57) ABSTRACT

An input apparatus is mountable on a vehicle. The input apparatus includes a touch panel connectable to a control unit mounted on the vehicle and configured to output a signal in accordance with a manipulation input performed on a manipulation input surface; a vibrating element configured to generate a vibration in the manipulation input surface; and a drive controlling part configured to drive the vibrating element by using a driving signal causing the vibrating element to generate a natural vibration in an ultrasound-frequency-band in the manipulation input surface.

### CROSS-REFERENCE TO RELATED APPLICATION

This application is a continuation application of International Application PCT/JP2014/053445 filed on Feb. 14, 2014 and designated the U.S., the entire contents of which are incorporated herein by reference.

### FIELD

The embodiment discussed herein relates to an input apparatus.

### BACKGROUND

A tactile sensation producing apparatus is known in the related art which includes a display, a contact detector that detects a contact state of user's manipulation to the display and a haptic vibration generating part which generates haptic vibration that gives a designated sensation to the user's body-part contacting the display (for example, see Patent Document 1).

The tactile sensation producing apparatus further includes a vibration waveform data generating means which generates a waveform data based on a detected result of the contact detector. The waveform data is used to generate the haptic vibration. The tactile sensation producing apparatus further includes an ultrasound modulating means which performs a modulating process on the waveform data, generated by the vibration waveform data generating means, by utilizing ultrasound as a carrier wave and outputs an ultrasound signal generated by the modulating process to the haptic vibration generating means as a signal used to generate the haptic vibration.

The ultrasound modulating means performs either a frequency modulation or a phase modulation. The ultrasound modulating means further performs an amplitude modulation.

However, an ultrasound frequency used in the conventional tactile sensation producing apparatus may be any frequency as long as the frequency is higher than that of an audio frequency (about 20 kHz). No specific setting is made for the ultrasound frequency. Accordingly, the tactile sensation producing apparatus does not provide a fine tactile sensation to the user.

In recent years, a manipulation part of an input interface (input apparatus) of a mirror controller, a power window controller, an air conditioner controller, an audio controller, a navigation device or the like of a vehicle has become flat, for example.

Such a vehicular input apparatus may be manipulated when a user drives the car, for example. Thus, when the user can sense manipulation contents with tactile sensations, convenience becomes higher.

### RELATED-ART DOCUMENTS

### Patent Documents

[Patent Document 1] Japanese Laid-open Patent Publication No. 2010-231609

### SUMMARY

According to an aspect of the embodiment, an input apparatus is mountable on a vehicle. The input apparatus includes a touch panel connectable to a control unit mounted on the vehicle and configured to output a signal in accordance with a manipulation input performed on a manipulation input surface; a vibrating element configured to generate a vibration in the manipulation input surface; and a drive controlling part configured to drive the vibrating element by using a driving signal causing the vibrating element to generate a natural vibration in an ultrasound-frequency-band in the manipulation input surface.

### BRIEF DESCRIPTION OF DRAWINGS

FIG. 1 is a diagram illustrating an input apparatus of an embodiment in plan view;

FIG. 2 is a diagram illustrating a cross-sectional view of the input apparatus taken along a line A-A of FIG. 1;

FIG. 3A is a diagram illustrating crests and troughs of a standing wave formed in parallel with a short side of a top panel;

FIG. 3B is a diagram illustrating the crests and the troughs of the standing wave formed in parallel with the short side of the top panel;

FIG. 4A is a diagram illustrating a case where a kinetic friction force applied to a fingertip varies when a natural vibration in an ultrasound-frequency-band is generated in the top panel of the input apparatus;

FIG. 4B is a diagram illustrating a case where the kinetic friction force applied to the fingertip varies when the natural vibration in the ultrasound-frequency-band is generated in the top panel of the input apparatus;

FIG. 5 is a diagram illustrating a configuration of the input apparatus according to the embodiment;

FIG. 6A is a diagram illustrating data stored in a memory;

FIG. 6B is a diagram illustrating data stored in the memory;

FIG. 7 is a diagram illustrating the surrounding of a driver's seat in a compartment of a vehicle;

FIG. 8 is a diagram transparently illustrating an internal configuration of an input apparatus of a working example 1 in plan view;

FIG. 9 is a diagram illustrating the input apparatus of the working example 1 in plan view;

FIG. 10 is a diagram illustrating an example of driving patterns of a drive controlling part of the input apparatus of the working example 1;

FIG. 11 is a diagram illustrating a flowchart executed by the drive controlling part of the input apparatus according to the working example 1;

FIG. 12 is a diagram illustrating an example of driving patterns of the drive controlling part of the input apparatus according to a variation example of the working example 1;

FIG. 13 is a diagram transparently illustrating an internal configuration of an input apparatus of a working example 2 in plan view;

FIG. 14 is a diagram illustrating the input apparatus of the working example 2 in plan view;

FIG. 15 is a diagram illustrating an example of driving patterns of the drive controlling part of the input apparatus of the working example 2;

FIG. 16 is a diagram illustrating a flowchart executed by the drive controlling part of the input apparatus according to the working example 2 corresponding to a manipulation of a manipulation part;

FIG. 17 is a diagram transparently illustrating an internal configuration of an input apparatus of a working example 3 in plan view;

FIG. 18 is a diagram illustrating the input apparatus of the working example 3 in plan view;

FIG. 19 is a diagram illustrating an example of driving patterns of the drive controlling part of the input apparatus of the working example 3;

FIG. 20 is a diagram illustrating a flowchart executed by the drive controlling part of the input apparatus according to the working example 3 corresponding to the manipulation of the manipulation part;

FIG. 21 is a diagram illustrating another example of driving patterns of the drive controlling part of the input apparatus of the working example 3;

FIG. 22 is a diagram transparently illustrating an internal configuration of an input apparatus of a working example 4 in plan view;

FIG. 23 is a diagram illustrating an operating state of the input apparatus of the working example 4 in plan view;

FIG. 24 is a diagram illustrating an operating state of an input apparatus of a working example 5 in plan view;

FIG. 25 is a diagram illustrating an operating state of an input apparatus of a working example 6 in plan view; and

FIG. 26 is a diagram illustrating an operating state of an input apparatus of a working example 7 in plan view.

### DESCRIPTION OF EMBODIMENT

Hereinafter, embodiments to which an input apparatus of the present invention is applied will be described.

### Embodiment

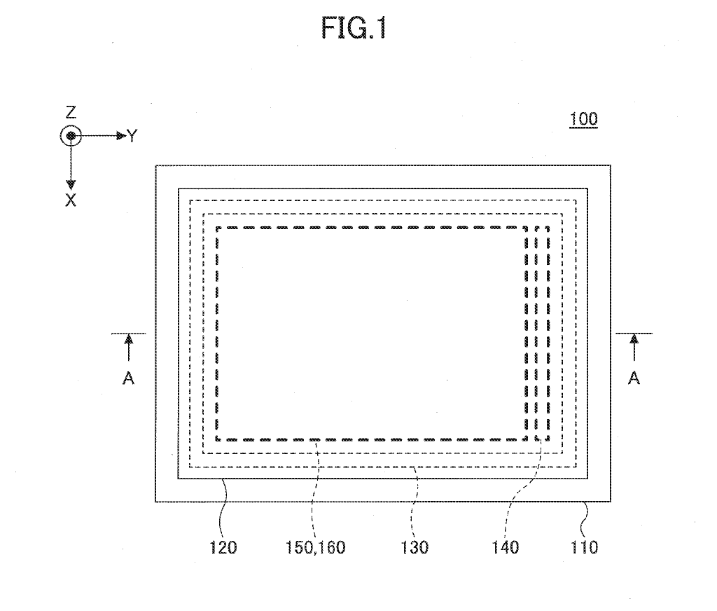

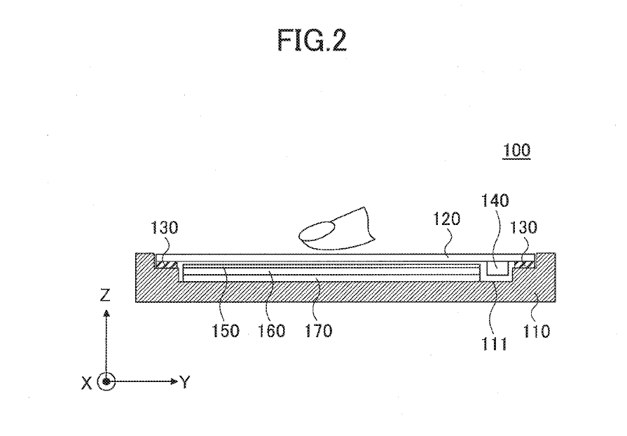

FIG. 1 is a diagram illustrating an input apparatus 100 of the embodiment in plan view. FIG. 2 is a diagram illustrating a cross-sectional view of the input apparatus 100 taken along a line A-A of FIG. 1. A XYZ coordinate system as an orthogonal coordinate system is defined as illustrated in FIGS. 1 and 2.

The input apparatus 100 includes a housing 110, a top panel 120, a double-faced adhesive tape 130, a vibrating element 140, a touch panel 150, a display panel 160, and a substrate 170.

The input apparatus 100 is mounted on a vehicle. The input apparatus 100 is an input interface having the touch panel 150 as a manipulation input part. The input apparatus 100 may be used as a manipulation part of a navigation device, an audio controller, an air conditioner controller, a power window controller, a mirror controller, or the like.

The housing 110 is made of a plastic, for example. As illustrated in FIG. 2, the substrate 170, the display panel 160 and the touch panel 150 are contained in a concave portion 111 of the housing 110, and the top panel 120 is adhered to the housing 110 by the double-faced adhesive tape 130.

The top panel 120 is a plate-shaped member having a rectangular shape in plan view and is made of a transparent glass or a reinforced plastic such as polycarbonate. A surface of the top panel 120 which is located on a positive side in Z axis direction is one example of a manipulation input surface into which the user of the input apparatus 100 performs a manipulation input.

The vibrating element 140 is bonded on a surface of the top panel 120 which is located on a negative side in Z axis direction, and four sides in plan view of the top panel 120 are adhered to the housing 110 by the double-faced adhesive tape 130. Herein, the double-faced adhesive tape 130 is not necessarily a rectangular-ring-shaped member in plan view as illustrated in FIG. 2, as long as the double-faced adhesive tape 130 can adhere four sides of the top panel 120 to the housing 110.

The touch panel 150 is disposed on the negative side in Z axis direction of the top panel 120. The top panel 120 is provided in order to protect the surface of the touch panel 150. Another panel, protection film or the like may be provided on the surface of the top panel 120.

In a state where the vibrating element 140 is bonded to the surface of the top panel 120 located on the negative side in Z axis direction, the top panel 120 vibrates if the vibrating element 140 is being driven. In the embodiment, a standing wave is generated in the top panel 120 by causing the top panel 120 to vibrate at a natural vibration frequency (natural resonance frequency or eigenfrequency) of the top panel 120. Because the vibrating element 140 is bonded to the top panel 120, it is preferable to determine the natural vibration frequency in consideration of a weight of the vibrating element 140 of the like, in a practical manner.

The vibrating element 140 is bonded on the surface of the top panel 120 which is located on the negative side in Z axis direction at a location along the short side extending in X axis direction at a positive side in Y axis direction. The vibrating element 140 may be any element as long as it can generate vibration in an ultrasound-frequency-band. A piezoelectric element such as a piezo element is used as the vibrating element 140, for example.

The vibrating element 140 is driven in accordance with a driving signal output from the drive controlling part which will be described later. An amplitude (intensity) and a frequency of the vibration output from the vibrating element 140 is set (determined) by the driving signal. An on/off action of the vibrating element 140 is controlled in accordance with the driving signal.

The ultrasound-frequency-band is a frequency band which is higher than or equal to about 20 kHz, for example. According to the input apparatus 100 of the embodiment, the frequency at which the vibrating element 140 vibrates is equal to a number of vibrations per unit time (frequency) of the top panel 120. Accordingly, the vibrating element 140 is driven in accordance with the driving signal so that the vibrating element 140 vibrates at a number of natural vibrations per unit time (natural vibration frequency) of the top panel 120.

The touch panel 150 is disposed on an upper side (positive side in Z axis direction) of the display panel 160 and is disposed on a lower side (negative side in Z axis direction) of the top panel 120. The touch panel 150 is one example of a coordinate detector which detects a position at which the user of the input apparatus 100 touches the top panel 120. Hereinafter, the position is referred to as a position of the manipulation input.

The display panel 160 disposed under the touch panel 150 displays various GUI buttons or the like (hereinafter referred to as GUI input part(s) 102). The user of the input apparatus 100 ordinarily touches the top panel 120 with a fingertip in order to manipulate (operate) the GUI input part.

The touch panel 150 is any coordinate detector as long as it can detect the position of the manipulation input onto the top panel 120 performed by the user. The touch panel 150 may be a capacitance type coordinate detector or a resistance film type coordinate detector, for example. Hereinafter, the embodiment in which the touch panel 150 is the capacitance type coordinate detector will be described. In a case where the touch panel 150 is a capacitance type, the touch panel 150 can detect the manipulation input performed on the top panel 120 even if there is a clearance gap between the touch panel 150 and the top panel 120.

Although the top panel 120 is disposed on the manipulation input surface side of the touch panel 150 in the present embodiment, the top panel 120 may be integrated with the touch panel 150. In this case, the surface of the touch panel 150 is equal to the surface of the top panel 120 as illustrated in FIGS. 1 and 2, and the surface of the touch panel 150 becomes the manipulation input surface. Otherwise, the top panel 120 as illustrated in FIGS. 1 and 2 may be omitted. In this case, the surface of the touch panel 150 constitutes the manipulation input surface. In this case, the vibrating element 140 vibrates the manipulation input surface at a natural vibration frequency of a member having the manipulation input surface.

In a case where the touch panel 150 is a capacitance type, the touch panel 150 may be disposed on the top panel 120. In this case, the surface of the touch panel 150 constitutes the manipulation input surface. In a case where the touch panel 150 is a capacitance type, the top panel 120 as illustrated in FIGS. 1 and 2 may be omitted. In this case, the surface of the touch panel 150 constitutes the manipulation input surface. In this case, the vibrating element 140 vibrates the manipulation input surface at a natural vibration frequency of a member having the manipulation input surface.

The display panel 160 is a display part which displays an image. The display panel 160 may be a liquid crystal display panel, an organic Electroluminescence (EL) panel or the like, for example. The display panel 160 is disposed in the concave portion 111 of the housing 110 and is disposed on (the positive side in Z axis direction of) the substrate 170.

The display panel 160 is driven and controlled by a driver Integrated Circuit (IC) and displays the GUI input part, an image, characters, symbols, graphics or the like in accordance with an operating state of the input apparatus 100.

The substrate 170 is disposed in the concave portion 111 of the housing 110. The display panel 160 and the touch panel 150 are disposed on the substrate 170. The display panel 160 and the touch panel 150 are fixed to the substrate 170 and the housing 110 by a holder or the like (not shown).

On the substrate 170, a drive controlling apparatus which will be described hereinafter and circuits or the like that are necessary for driving the input apparatus 100 are mounted.

In the input apparatus 100 having the configuration as described above, when the user touches the top panel 120 with the fingertip and a movement of the fingertip is detected, the drive controlling part mounted on the substrate 170 drives the vibrating element 140 so that the top panel 120 vibrates at a frequency in the ultrasound-frequency-band. The frequency in the ultrasound-frequency-band is a resonance frequency of a resonance system including the top panel 120 and the vibrating element 140. A standing wave is generated in the top panel 120 at the frequency.

The input apparatus 100 generates the standing wave in the ultrasound-frequency-band in the top panel 120 to provide a tactile sensation (haptic sensation) to the user through the top panel 120

The input apparatus 100 may be used as a multi input apparatus integrating functions of the manipulation parts of the navigation device, the audio controller, the air conditioner controller, the power window controller, the mirror controller, and the like, for example. In a case where the input apparatus 100 is used as the multi input apparatus, the functions as various manipulation pats may be switched by switching the GUI input parts or the like displayed on the display panel 160.

Although the input apparatus 100 includes the display panel 160 as illustrated in FIGS. 1 and 2, the input apparatus 100 does not have to include the display panel 160. For example, a graphic such as a button for representing a position to be manipulated may be represented in the top panel 120 by printing or the like to guide the manipulation input of the user to the part of the graphic such as the button.

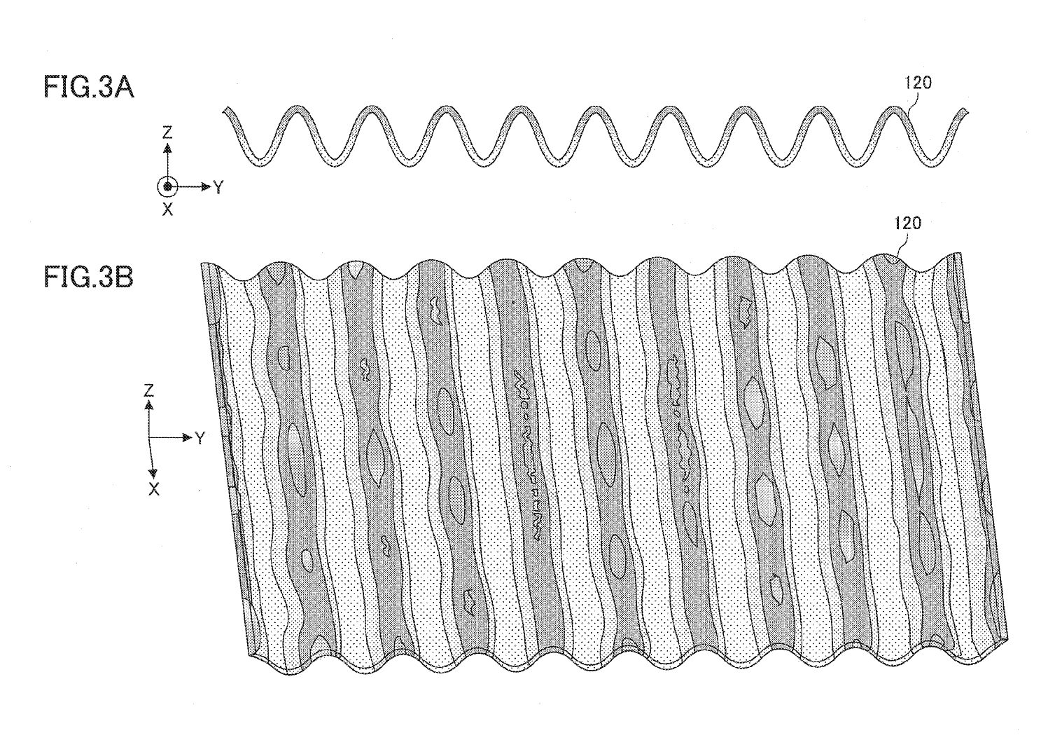

Next, the standing wave generated in the top panel 120 is described with reference to FIGS. 3A and 3B.

FIGS. 3A and 3B are diagrams illustrating crests and troughs of the standing wave formed in parallel with the short side of the top panel 120 included in the standing waves generated in the top panel 120 by the natural vibration in the ultrasound-frequency-band. FIG. 3A illustrates a side view, and FIG. 3B illustrates a perspective view. In FIGS. 3A and 3B, a XYZ coordinate system similar to that described in FIGS. 1 and 2 is defined. In FIGS. 3A and 3B, the amplitude of the standing wave is overdrawn in an easy-to-understand manner. The vibrating element 140 is omitted in FIGS. 3A and 3B.

The natural vibration frequency (the resonance frequency) f of the top panel 120 is represented by formulas (1) and (2) where E is the Young's modulus of the top panel 120, ρ is the density of the top panel 120, δ is the Poisson's ratio of the top panel 120, l is the long side dimension of the top panel 120, t is the thickness of the top panel 120, and k is a periodic number of the standing wave along the direction of the long side of the top panel 120. Because the standing wave has the same waveforms in every half cycle, the periodic number k takes values at 0.5 intervals. The periodic number k takes 0.5, 1, 1.5, 2 . . . .

$$\begin{matrix}f = \frac{π {k}^{2} t}{{l}^{2}} \sqrt{\frac{E}{3 ρ ( 1 - {δ}^{2} )}} & ( 1 ) \\ f = α {k}^{2} & ( 2 )\end{matrix}$$

The coefficient a included in formula (2) corresponds to coefficients other than k² included in formula (1).

A waveform of the standing wave as illustrated FIGS. 3A and 3B is obtained in a case where the periodic number k is 10, for example. In a case where a sheet of Gorilla (registered trademark) glass of which the length l of the long side is 140 mm, the length of the short side is 80 mm, and the thickness t is 0.7 mm is used as the top panel 120, for example, the natural vibration number f is 33.5 kHz, if the periodic number k is 10. In this case, a frequency of the driving signal is 33.5 kHz.

The top panel 120 is a planar member. If the vibrating element 140 (see FIGS. 1 and 2) is driven and the natural vibration in the ultrasound-frequency-band is generated in the top panel 120, the top panel 120 is bent as illustrated in FIGS. 3A and 3B. As a result, the standing wave is generated in the surface of the top panel 120.

In the present embodiment, the single vibrating element 140 is bonded on the surface of the top panel 120 which is located on the negative side in Z axis direction at the location along the short side extending in X axis direction at the positive side in Y axis direction. The input apparatus 100 may include two vibrating elements 140. In a case where the input apparatus 100 includes two vibrating elements 140, another vibrating element 140 may be bonded on the surface of the top panel 120 which is located on the negative side in Z axis direction at a location along the short side extending in X axis direction at a negative side in Y axis direction. In this case, the two vibrating elements 140 may be axisymmetrically disposed with respect to a center line of the top panel 120 parallel to the two short sides of the top panel 120.

In a case where the input apparatus 100 includes two vibrating elements 140, the two vibrating elements 140 may be driven in the same phase, if the periodic number k is an integer number. If the periodic number k is an odd number, the two vibrating elements 140 may be driven in opposite phases.

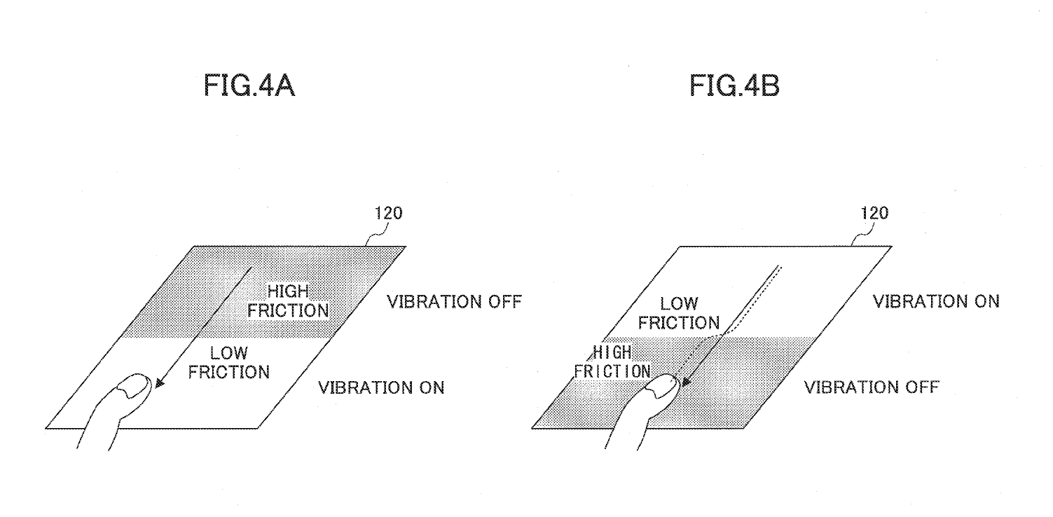

Next, the natural vibration at ultrasound-frequency-band generated in the top panel 120 of the input apparatus 100 is described with reference to FIGS. 4A and 4B.

FIGS. 4A and 4B are diagrams illustrating cases where a kinetic friction force applied to the fingertip varies when the natural vibration in the ultrasound-frequency-band is generated in the top panel 120 of the input apparatus 100. In FIGS. 4A and 4B, the manipulation input is performed with the fingertip. In FIGS. 4A and 4B, the user touches the top panel 120 with the fingertip and performs the manipulation input by tracing the top panel 120 with the fingertip in a direction from a far side to a near side with respect to the user. An on/off state of the vibration is switched by controlling an on/off state of the vibrating element 140 (see FIGS. 1 and 2).

In FIGS. 4A and 4B, areas which the fingertip touches while the vibration is turned off are indicated in grey in the depth direction of the top panel 120. Areas which the fingertip touches while the vibration is turned on are indicated in white in the depth direction of the top panel 120.

As illustrated in FIGS. 3A and 3B, the natural vibration in the ultrasound-frequency-band occurs on an entire surface of the top panel 120. FIGS. 4A and 4B illustrate operation patterns in which the on/off state of the natural vibration is switched while the user's fingertip is tracing the top panel 120 from the far side to the near side.

Accordingly, in FIGS. 4A and 4B, areas which the fingertip touches while the vibration is turned off are indicated in grey in the depth direction of the top panel 120. Areas which the fingertip touches while the vibration is turned on are indicated in white in the depth direction of the top panel 120.

In the operation pattern as illustrated in FIG. 4A, the vibration is turned off when the user's fingertip is located on the far side of the top panel 120, and the vibration is turned on in the process of tracing the top panel 120 with the fingertip toward the near side.

On the contrary, in the operation pattern as illustrated in FIG. 4B, the vibration is turned on when the user's fingertip is located on the far side of the top panel 120, and the vibration is turned off in the process of tracing the top panel 120 with the fingertip toward the near side.

In a state where the natural vibration in the ultrasound-frequency-band is generated in the top panel 120, a layer of air intervenes between the surface of the top panel 120 and the fingertip. The layer of air is provided by a squeeze film effect. As a result, a kinetic friction coefficient on the surface of the top panel 120 is decreased when the user traces the surface with the fingertip.

Accordingly, in the grey area located on the far side of the top panel 120 as illustrated in FIG. 4A, the kinetic friction force applied to the fingertip increases. In the white area located on the near side of the top panel 120, the kinetic friction force applied to the fingertip decreases.

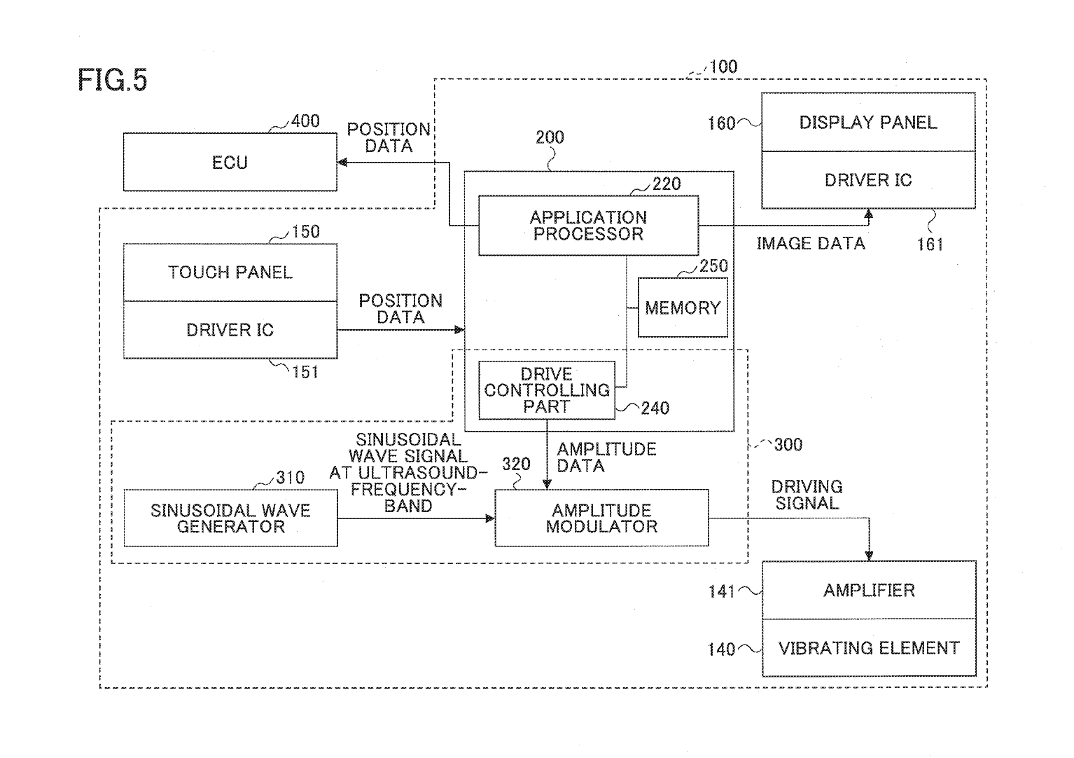

Therefore, the user who is performing the manipulation input to the top panel 120 in a manner as illustrated in FIG. 5A senses a reduction of the kinetic friction force applied to the fingertip when the vibration is turned on. As a result, the user senses a slippery or smooth touch (texture) with the fingertip. In this case, the user senses as if a concave portion were present on the surface of the top panel 120 when the surface of the top panel 120 becomes slippery and the kinetic friction force decreases.

On the contrary, in the white area located on the far side of the top panel 120 as illustrated in FIG. 4B, the kinetic friction force applied to the fingertip decreases. In the grey area located on the near side of the top panel 120, the kinetic friction force applied to the fingertip increases.

Therefore, the user who is performing the manipulation input in the top panel 120 in a manner as illustrated in FIG. 4B senses an increase of the kinetic friction force applied to the fingertip when the vibration is turned off. As a result, the user senses a grippy or scratchy touch (texture) with the fingertip. In this case, the user senses as if a convex portion were present on the surface of the top panel 120 when the surface of the top panel 120 becomes grippy and the kinetic friction force increases.

Accordingly, the user can sense a concavity or convexity with the fingertip in the cases as illustrated in FIGS. 4A and 4B. For example, “The Printed-matter Typecasting Method for Haptic Feel Design and Sticky-band Illusion” (the Collection of papers of the 11th SICE system integration division annual conference (SI2010, Sendai) 174-177, 2010-12) discloses that a human can sense a concavity or a convexity. “Fishbone Tactile Illusion” (Collection of papers of the 10th Congress of the Virtual Reality Society of Japan (September, 2005)) discloses that a human can sense a concavity or a convexity as well.

Although a variation of the kinetic friction force when the vibration is switched on or off is described above, a variation of the kinetic friction force similar to those described above is obtained when the amplitude (intensity) of the vibrating element 140 is varied.

In the following, a configuration of the input apparatus 100 according to the embodiment is described with reference to FIG. 5.

FIG. 5 is a diagram illustrating the configuration of the input apparatus 100 according to the embodiment.

The input apparatus 100 includes the vibrating element 140, an amplifier 141, the touch panel 150, a driver Integrated Circuit (IC) 151, the display panel 160, a driver IC 161, a controller 200, a sinusoidal wave generator 310 and an amplitude modulator 320.

An electronic control unit (ECU) 400 of the vehicle is connected to the input apparatus 100.

The controller 200 includes an application processor 220, a drive controlling part 240, and a memory 250. The controller 200 is realized by an IC chip, for example.

The drive controlling part 240, the sinusoidal wave generator 310, and the amplitude modulator 320 constitute a drive controlling apparatus 300. Although an embodiment in which the application processor 220, the drive controlling part 240 and the memory 250 are included in the single controller 200 is described, the drive controlling part 240 may be disposed outside of the controller 200 and realized by another IC chip or a processor. In this case, data which is necessary for a drive control performed by the drive controlling part 240 among data stored in the memory 250 may be stored in another memory disposed in the drive control apparatus 300.

In FIG. 5, the housing 110, the top panel 120, the double-faced adhesive tape 130, and the substrate 170 (see FIG. 1) are omitted. Herein, the amplifier 141, the driver IC 151, the driver IC 161, the drive controlling part 240, the memory 250, the sinusoidal wave generator 310 and the amplitude modulator 320 are described.

The amplifier 141 is disposed between the drive controlling apparatus 300 and the vibrating element 140. The amplifier 141 amplifies the driving signal output from the drive controlling apparatus 300 and drives the vibrating element 140.

The driver IC 151 is connected to the touch panel 150. The driver IC 151 detects position data representing the position on the touch panel 150 at which the manipulation input is performed and outputs the position data to the controller 200. As a result, the position data is input to the application processor 220 and the drive controlling part 240. Inputting the position data to the drive controlling part 240 is equal to inputting the position data to the drive controlling apparatus 300.

The driver IC 161 is connected to the display panel 160. The driver IC 161 inputs image data output from the drive controlling apparatus 300 to the display panel 160 and displays a picture image on the display panel 160 based on the image data. Accordingly, the GUI input part, the picture image or the like are displayed on the display panel 160 based on the image data.

The application processor 220 outputs image data that represents GUI input parts, an image, characters, symbols, figures, or the like. The image data is required for the ECU 400 to perform drive control. For example, in a case where the ECU 400 performs the drive control of the navigation device, the audio controller, the air conditioner controller, the power window controller, the mirror controller or the like, the application processor 220 outputs, to the driver IC 161, the image data representing the GUI input parts or the like required for the drive control.

The driver IC 151 inputs the position data to the application processor 220. The application processor 220 outputs the position data to the ECU 400. In this way, the position data obtained by the manipulation input on the touch panel 150 is input to the ECU 400.

The position data may be directly input to the ECU 400 from the driver IC 151 without going through the application processor 220.

The drive controlling part 240 outputs amplitude data to the amplitude modulator 320. The amplitude data represents an amplitude value used for controlling an intensity of the driving signal used for driving the vibrating element 140. The amplitude data that represents the amplitude value may be stored in the memory 250.

The input apparatus 100 of the embodiment causes the top panel 120 to vibrate in order to vary the kinetic friction force applied to the user's fingertip when the fingertip traces along the surface of the top panel 120.

There are various manipulation inputs such as a flick operation, a swipe operation and a drag operation, for example, that the user performs when the user moves the fingertip along the surface of the top panel 120.

The flick operation is performed by flicking (snapping) the surface of the top panel 120 for a relatively-short distance with the fingertip. The swipe operation is performed by swiping the surface of the top panel 120 for a relatively-long distance with the fingertip. The drag operation is performed by moving the fingertip along the surface of the top panel 120 while selecting a button or the like displayed on the display panel 160 when the user slides the button of the like.

The manipulation inputs that are performed by moving the fingertip along the surface of the top panel 120, such as the flick operation, the swipe operation and the drag operation that are introduced as examples, are used differently depending on a kind of the GUI input part of the like displayed on the display panel 160.

In addition to the above described processes, the drive controlling part 240 may set the amplitude value in accordance with a temporal change degree of the position data.

Here, a moving speed of the user's fingertip tracing along the surface of the top panel 120 is used as the temporal change degree of the position data. The drive controlling part 240 may calculate the moving speed of the user's fingertip based on a temporal change degree of the position data input from the driver IC 151.

The higher the moving speed becomes, the smaller the input apparatus 100 controls the amplitude value to be, for the sake of making an intensity of the tactile sensation sensed by the user constant regardless of the moving speed of the fingertip, for example. The lower the moving speed becomes, the greater the input apparatus 100 controls the amplitude value to be, for the sake of making the intensity constant regardless of the moving speed of the fingertip, for example.

Data which represents a relationship between the amplitude data, representing the amplitude value, and the moving speed may be stored in the memory 250.

Although the amplitude value in accordance with the moving speed is set by using the data that represents the relationship between the amplitude data representing the amplitude value and the moving speed in the present embodiment, the amplitude value A may be calculated based on formula (3). The higher the moving speed becomes, the smaller the amplitude value A calculated by formula (3) becomes.

The lower the moving speed becomes, the greater the amplitude value A calculated by formula (3) becomes.

A=A₀\sqrt{|V|/a} (3)

“A₀” is a reference value of the amplitude, “V” represents the moving speed of the fingertip and “a” is a designated constant value. In a case where the amplitude value A is calculated by using formula (3), data representing formula (3) and data representing the reference value A₀ and the designated constant value a may be stored in the memory 250.

The drive controlling part 240 causes the vibrating element 140 to vibrate when the moving speed becomes greater than or equal to a designated threshold speed.

Accordingly, the amplitude value represented by the amplitude data output from the drive controlling part 240 becomes zero in a case where the moving speed is less than the designated threshold speed. The amplitude value is set to a designated amplitude value corresponding to the moving speed in a case where the moving speed is greater than or equal to the designated threshold speed. In a case where the moving speed is greater than or equal to the designated threshold speed, the higher the moving speed becomes, the smaller the amplitude value becomes. In a case where the moving speed is greater than or equal to the designated threshold speed, the lower the moving speed becomes, the greater the amplitude value becomes.

The memory 250 stores data that associates area data with pattern data. The area data represents the GUI input part or the like to which the manipulation input is performed. The pattern data represents vibration patterns.

The sinusoidal wave generator 310 generates sinusoidal waves used for generating the driving signal which causes the top panel 120 to vibrate at the natural vibration frequency. For example, in a case of causing the top panel 120 to vibrate at 33.5 kHz of the natural vibration frequency f, a frequency of the sinusoidal waves becomes 33.5 kHz. The sinusoidal wave generator 310 inputs a sinusoidal wave signal in the ultrasound-frequency-band to the amplitude modulator 320.

The amplitude modulator 320 generates the driving signal by modulating an amplitude of the sinusoidal wave signal input from the sinusoidal wave generator 310 based on the amplitude data input from the drive controlling part 240. In the basic operation, the amplitude modulator 320 modulates the amplitude of the sinusoidal wave signal in the ultrasound-frequency-band input from the sinusoidal wave generator 310 and does not modulate a frequency and a phase of the sinusoidal wave signal in order to generate the driving signal.

Therefore, the driving signal output from the amplitude modulator 320 is a sinusoidal wave signal in the ultrasound-frequency-band obtained by modulating only the amplitude of the sinusoidal wave signal in the ultrasound-frequency-band input from the sinusoidal wave generator 310. In a case where the amplitude data is zero, the amplitude of the driving signal becomes zero. This is the same as the amplitude modulator 320 not outputting the driving signal.

The amplitude modulator 320 can modulate the sinusoidal wave signal in the ultrasound-frequency-band input from the sinusoidal wave generator 310 by using a sinusoidal wave signal in an audible frequency band. In this case, a driving signal output from the amplitude modulator 320 becomes a signal in which a driving signal in the audible frequency band is superimposed on a driving signal in the ultrasound-frequency-band and an amplitude of the signal is set by the amplitude modulator 320.

The ECU 400 is mounted on the vehicle and serves as a control unit that controls the navigation device, the audio controller, the air conditioner controller, the power window controller, the mirror controller, and the like, for example. Position data detected based on the manipulation input on the touch panel 150 of the input apparatus 100 is input to the ECU 400 via the application processor 220.

The ECU 400 may determine manipulation contents based on the position data input via the application processor 220 to control the navigation device, the audio controller, the air conditioner controller, the power window controller, the mirror controller, and the like, for example.

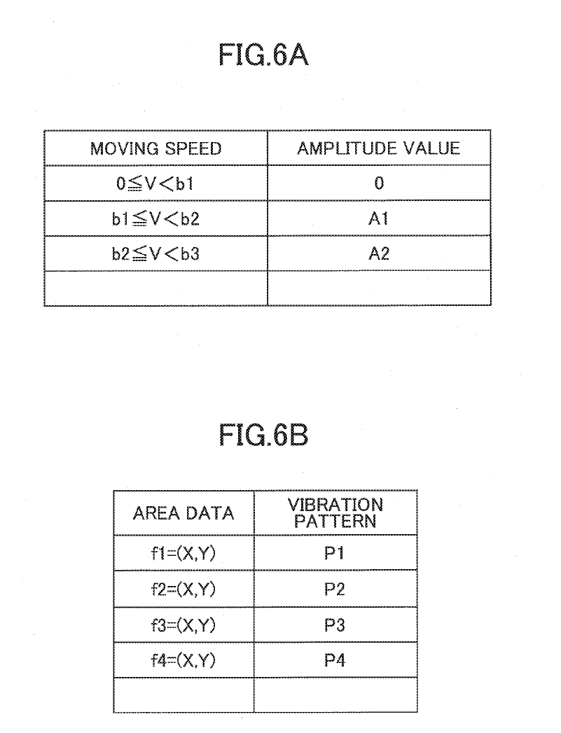

In the following, the data stored in the memory 250 is described with reference to FIGS. 6A and 6B.

FIGS. 6A and 6B are diagrams illustrating the data stored in the memory 250.

The data illustrated in FIG. 6A associates the amplitude data, representing the amplitude value, with the moving speed. According to the data as illustrated in FIG. 6A, the amplitude value is set to 0 in a case where the moving speed V is greater than or equal to 0 and less than b1 (0<=V<b1), the amplitude value is set to A1 in a case where the moving speed V is greater than or equal to b1 and less than b2 (b1<=V<b2), and the amplitude value is set to A2 in a case where the moving speed V is greater than or equal to b2 and less than b3 (b2<=V<b3).

The data illustrated in FIG. 6B is vibration control data that associates area data, representing coordinate values of areas where the GUI input parts or the like to which the manipulation inputs are performed are displayed, with the pattern data representing the vibration patterns.

Formulas f1 to f4, representing the coordinate values of the areas where the GUI input parts or the like to which the manipulation inputs are performed are displayed, are illustrated as the area data. P1 to P4 are illustrated as the pattern data representing the vibration patterns.

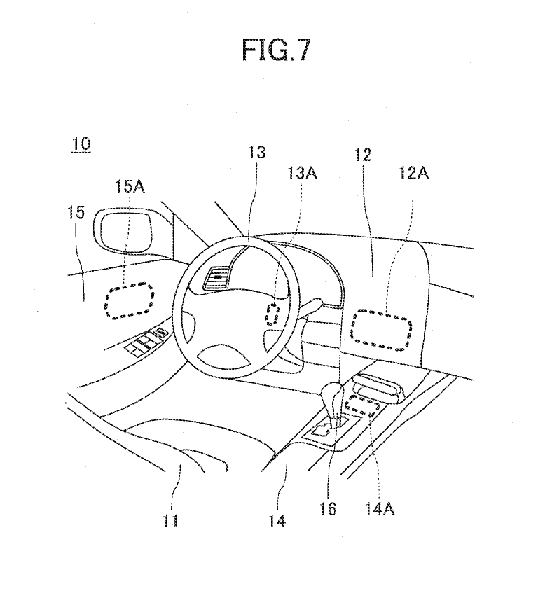

Here, a place where the input apparatus 100 of the embodiment can be placed in a compartment of the vehicle 10 is described with reference to FIG. 7.

FIG. 7 is a diagram illustrating the surrounding of a driver's seat 11 in the compartment of the vehicle 10. The driver's seat 11, a dashboard 12, a steering wheel 13, a center console 14, a lining 15 of a door and the like are disposed in the compartment of the vehicle 10. The vehicle 10 may be a Hybrid Vehicle (HV), an Electric Vehicle (EV), a gasoline engine car, a diesel engine car, a Fuel Cell Vehicle (FCV), a hydrogen automobile, or the like, for example.

The input apparatus 100 of the embodiment can be disposed on a center portion 12A of the dashboard 12, on a spoke portion 13A of the steering wheel 13, on a surrounding 14A of a shift lever 16 of the center console 14, a concave portion 15A of the lining 15 of the door, or the like, for example.

The input apparatus 100 of the embodiment may be disposed outside of the vehicle 10 though it is not illustrated in FIG. 7. For example, the input apparatus 100 may be disposed on the surrounding of a door handle and used as a manipulation part of an electronic lock.

In the following, input apparatuses 100A to 100G of working examples 1 to 7 disposed in the compartment of the vehicle 10 are described. Planar structures and cross-section structures of the input apparatuses 100A to 100G, which will be described later, are obtained by deforming the structure of the input apparatus 100 illustrated in FIGS. 1 and 2.

### WORKING EXAMPLE 1

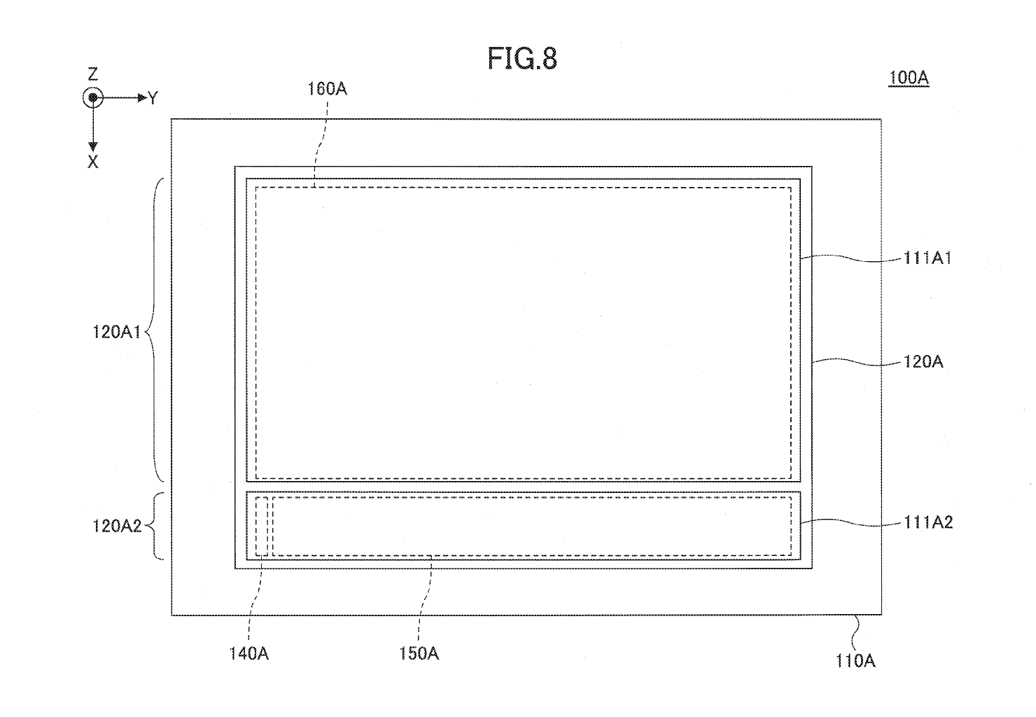

FIG. 8 is a diagram transparently illustrating an internal configuration of an input apparatus 100A of a working example 1 in plan view. The input apparatus 100A of the working example 1 may be used as an input part of the navigation device, for example. The input apparatus 100A of the working example 1 is disposed on the center portion 12A of the dashboard 12 or the like in the compartment of the vehicle 10 illustrated in FIG. 7, for example.

The input apparatus 100A includes a housing 110A, a top panel 120A, a vibrating element 140A, and a display panel 160A. In FIG. 8, the double-faced adhesive tape 130 and the substrate 170 are omitted.

Concave portions 111A1 and 112A are formed on the housing 110A of the input apparatus 100A illustrated in FIG. 8. The concave portion 111A1 is formed along the long side of the housing 110A on a more negative side than the concave portion 111A2 in x axis direction. The concave portion 111A1 has a rectangular shape in plan view.

The concave portion 112A is formed along the long side of the housing 110A on a more positive side than the concave portion 111A1 in x axis direction. The concave portion 112A has a rectangular shape in plan view. For example, a ratio of a length of the concave portion 111A1 to a length of the concave portion 111A2 is about 4 to 1 in x axis direction.

A display area 120A1 and a manipulation area 120A2 of the top panel 120A are described. The display area 120A1 is an area for displaying the navigation device and the manipulation area 120A2 is an area for manipulating the navigation device. The display area 120A1 is located at a negative side in x axis direction. The manipulation area 120A2 is located at a positive side in x axis direction.

The concave portion 111A is disposed in the display area 120A1. The concave portion 112A is disposed in the manipulation area 120A2. Thus, a ratio of a length of the display area 120A1 to a length of the manipulation area 120A2 is about 4 to 1 in x axis direction.

The display panel 160A is disposed inside of the concave portion 111A1. The display panel 160A is disposed on a bottom face of the concave portion 111A1. That is, the display panel 160A is disposed inside of the display area 120A1.

The vibrating element 140A and the touch panel 150A are disposed inside of the concave portion 111A2. The vibrating element 140A is attached to the back face of the top panel 120A at a negative side of the manipulation area 120A2 in y axis direction in plan view. The touch panel 150A is disposed on a bottom face of the concave portion 111A2 within an area of the manipulation area 120A2 except for the area where the vibrating element 140A is disposed.

A length of the vibrating element 140A of the input apparatus 100A of the working example 1 is equal to or less than one-quarter of that of the vibrating element 140 of the input apparatus 100 of the embodiment illustrated in FIG. 1 in x axis direction.

The input apparatus 100A of the working example 1 uses such a vibrating element 140A having the short length in x axis direction because it is needed to generate, only in the manipulation area 120A2 among the top panel 120A, a standing wave according to the natural vibration in the ultrasound-frequency-band of the top panel 120A.

In a case where the vibrating element 140 having the length substantially equal to a width of the top panel 120 in x axis direction is used as illustrated in FIG. 1, the standing wave of which the amplitude varies in the long side direction (y axis direction) of the top panel 120 is generated in the substantial whole of the width of the top panel 120 in x axis direction as illustrated in FIG. 3.

In contrast, when the vibrating element 140A having the short length in x axis direction is used as illustrated in FIG. 8, the standing wave having a width substantially corresponding to the width of the vibrating element 140A in x axis direction is generated. The amplitude of the standing wave varies in the long side direction of the top panel 120A.

Because the width of the touch panel 150A in x axis direction is short, the input apparatus 100A of the working example 1 uses the small vibrating element 140A corresponding to the width.

A double-faced adhesive tape corresponding to the double-faced adhesive tape 130 illustrated in FIGS. 1 and 2 is arranged on an area surrounding the concave portions 111A1 and the concave portion 111A2 along an outer periphery of the top panel 120A in plan view. The double-faced adhesive tape bonds the top panel 120A to the housing 110A.

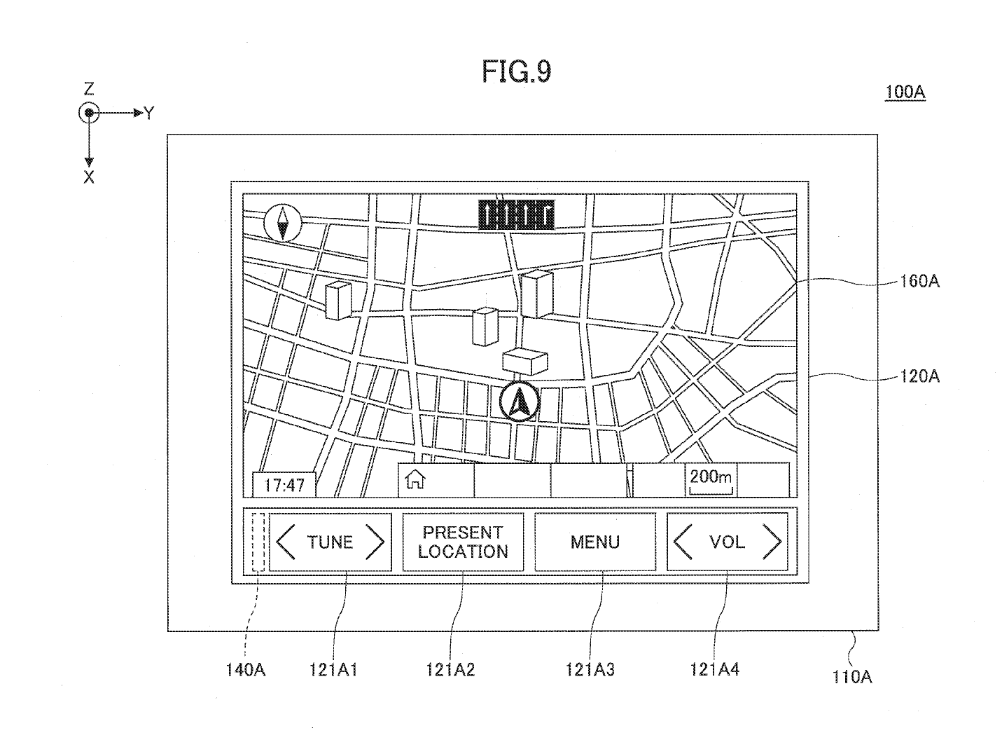

FIG. 9 is a diagram illustrating the input apparatus 100A of the working example 1 in plan view.

As illustrated in FIG. 9, the display panel 160A displays a map. Manipulation parts 121A1, 121A2, 121A3, and 121A4 are disposed in the area that illustrates the touch panel 150A in FIG. 8.

Characters, symbols and the like of the manipulation parts 121A1, 121A2, 121A3, and 121A4 are printed on the back face of the top panel 120A. Although the manipulation parts 121A1, 121A2, 121A3, and 121A4 should be seen even in a state where the input apparatus 100 is not operated as illustrated in FIG. 8, they are omitted in FIG. 8 for convenience of the description.

As the area data f1 to f4 illustrated in FIG. 6, positions in xy coordinate of the four areas, in which the manipulation parts 121A1, 121A2, 121A3 and 121A4 are printed, are determined and the four areas are converted into data, respectively. When the manipulation input is performed on the manipulation parts 121A1, 121A2, 121A3, and 121A4, the vibrating element 140A is driven by the drive controlling part 240 by using designated vibration patterns for each respective manipulation part 121A.

Such designated vibration patterns may be stored in the memory 250 in association with the area data of the four areas, in which the manipulation parts 121A1, 121A2, 121A3, and 121A4 are printed, as the vibration patterns P1 to P4 are associated with the area data f1 to f4 illustrated in FIG. 6B.

In a case where the manipulation input is performed, within the area where the touch panel 150A is located in plan view, on a part other than the manipulation parts 121A1, 121A2, 121A3, and 121A4, the input apparatus 100A of the working example 1 also causes the drive controlling part 240 to drive the vibrating element 140A.

Thus, among the area where the touch panel 150A is located in plan view, area data representing the area other than the manipulation parts 121A1, 121A2, 121A3, and 121A4 may be associated with data representing a vibration pattern as the area data f1 to f4 are associated with the vibration patterns P1 to P4 in the vibration control data illustrated in FIG. 6B.

The manipulation part 121A1 (TUNE) is a manipulation part for selecting a channel of radio. The manipulation part 121A2 (PRESENT LOCATION) is a manipulation part for selecting a display causing the present location to be a center in the navigation. The manipulation part 121A3 (MENU) is a manipulation part for causing the display panel 160A to display a menu screen. The manipulation part 121A4 (VOL) is a manipulation part for adjusting a sound volume.

When the manipulation input is performed on the surface of the top panel 120A within the four areas where the manipulation parts 121A1, 121A2, 121A3, and 121A4 are printed, the position data output from the touch panel 150A is input to the ECU 400. In this way, selection of the channel of the radio, selection of the display for causing the present location to be the center in the navigation, display of the menu screen on the display panel 160A, and adjustment of the sound volume can be performed, respectively.

In the input apparatus 100A of the working example 1, only a part (part corresponding to the manipulation area 120A2) where the vibrating element 140A and the touch panel 150A are present in x axis direction may be treated as an input apparatus. In this case, a part (the display area 120A1) where the display panel 160 is present may be treated as a display part attached to the input apparatus.

Although the characters, the symbols, and the like of the manipulation parts 121A1, 121A2, 121A3, and 121A4 are printed on the back face of the top panel 120A, the characters, the symbols, and the like of the manipulation parts 121A1, 121A2, 121A3, and 121A4 may be printed on the front face of the top panel 120A.

The characters, the symbols, and the like of the manipulation parts 121A1, 121A2, 121A3, and 121A4 may be represented with concave portions and convex portions by applying processing to the front face of the top panel 120A such as cutting. The characters, the symbols, and the like of the manipulation parts 121A1, 121A2, 121A3, and 121A4 may be displayed by illuminating light on the characters, the symbols, and the like formed by applying processing such as printing or cutting to the front face or the back face of the top panel 120A.

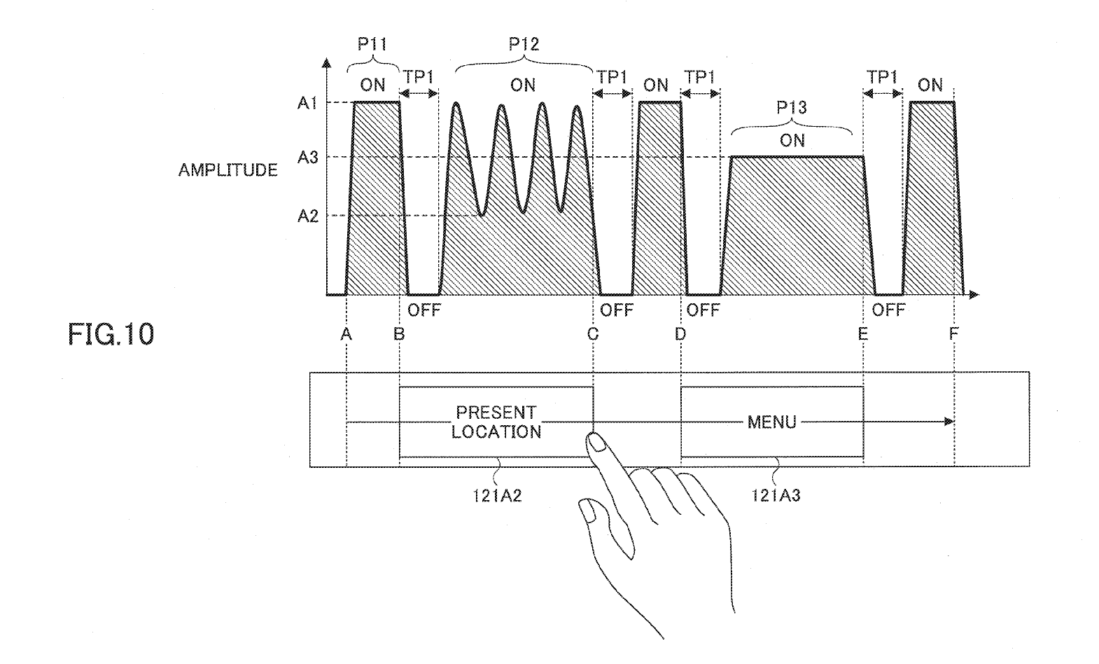

FIG. 10 is a diagram illustrating an example of driving patterns of the drive controlling part 240 of the input apparatus 100A of the working example 1. FIG. 10 illustrates the example of the driving patterns in a case where the manipulation parts 121A2 and 121A3 illustrated in FIG. 9 are manipulated.

In FIG. 10, a horizontal axis represents an arrangement direction (y axis direction) of the manipulation parts 121A2 and 121A3 in FIG. 9, and a vertical axis represents an amplitude of the driving signal. In FIG. 10, the position of the manipulation input moves at a constant speed to a positive side in y axis direction. Points A to F are illustrated in the lateral direction. All the points A to F are present inside of the area where the touch panel 150A is located in plan view.

When the manipulation input starts at the point A, the drive controlling part 240 starts to drive the vibrating element 140A. Because the point A is outside of the areas of the manipulation parts 121A2 and 121A3, the drive controlling part 240 drives the vibrating element 140A with a vibration pattern P11 to vibrate the top panel 120A at a frequency in the ultrasound-frequency-band.

The vibration pattern P11 represents a driving signal of which the amplitude is A1 and the frequency is 35 kHz. The vibration pattern P11 is data that represents a predetermined driving signal used in a case where the manipulation input is performed outside of the areas of the manipulation input parts 121A2 and 121A3.

In this way, when the vibrating element 140A is held in the on-state by the vibration pattern P11, the kinetic friction coefficient applied to the user's fingertip is decreased by the squeeze film effect and the fingertip becomes easy to move over the surface of the top panel 120A.

When the position of the manipulation input reaches the point B that is a boundary of the manipulation part 121A2, the drive controlling part 240 turns off the vibrating element 140A for a designated time period TP1. The drive controlling part 240 may turn the vibrating element 140A off by setting the amplitude to zero.

In this way, when the vibrating element 140A is turned off, the natural vibration in the ultrasound-frequency-band of the top panel 120 is turned off. As a result, the kinetic friction force applied to the user's fingertip increases and the user senses a grippy or scratchy touch (texture) with the fingertip. In this case, the user senses as if a convex portion were present on the surface of the top panel 120A when the surface of the top panel 120 becomes grippy and the kinetic friction force increases.

The vibrating element 140A is turned off only for the time period TP1. The time period TP1 may be about 50 milliseconds, for example. When the time period TP1 elapses, the drive controlling part 240 drives the vibrating element 140A with a vibration pattern P12 corresponding to the area data of the manipulation part 121A2.

The vibration pattern P12 illustrated in FIG. 10 is obtained by the amplitude modulator 320 modulating the driving signal of the vibration pattern P11 of which the amplitude is A1 and the frequency is 35 kHz. The amplitude modulator 320 uses the driving signal of which a maximum amplitude is A1, a minimum amplitude is A2, and the frequency is 200 Hz to modulate the vibration pattern P11. The driving signal that the amplitude modulator 320 finally outputs is a driving signal of which the maximum amplitude is A1, the minimum amplitude is A2, and the amplitude varies in a cycle of 200 Hz as illustrated in FIG. 10.

Because the driving signal of 200 Hz is a driving signal in an audible frequency band, the vibration pattern P12 is an example of a driving signal that causes a modulated vibration to occur. The modulated vibration is obtained by modulating the natural vibration (vibration pattern P11) in the ultrasound-frequency-band with a vibration of a designated pattern in the audible frequency band.

When the position of the manipulation input reaches the point C that is the boundary of the manipulation part 121A2, the drive controlling part 240 sets the amplitude value of the amplitude data to zero. In this way, the vibrating element 140A is turned off and the kinetic friction force applied to the fingertip increases. Thereby, the user feels as if a convex portion were present on the surface of the top panel 120A. The drive controlling part 240 turns off the vibrating element 140A for the time period TP1.

When the time period TP1 elapses, the drive controlling part 240 drives the vibrating element 140A with the vibration pattern P11 to vibrate the top panel 120A at the frequency in the ultrasound-frequency-band. This is because an area between the point C and the point D is the area between the manipulation parts 121A2 and 121A3, and is outside of the areas of the manipulation parts 121A2 and 121A3. Accordingly, here, the drive controlling part 240 drives the vibrating element 140A with the vibration pattern P11 that represents the predetermined driving signal.

When the position of the manipulation input reaches the point D that is a boundary of the manipulation part 121A3, the drive controlling part 240 turns off the vibrating element 140A for the designated time period TP1. In this way, the user senses a grippy or scratchy touch (texture) with the fingertip and feels as if the convex portion were present on the surface of the top panel 120A. The drive controlling part 240 turns off the vibrating element 140A for the time period TP1.

When the time period TP1 elapses, the drive controlling part 240 drives the vibrating element 140A with a vibration pattern P13 corresponding to the area data of the manipulation part 121A3. The vibration pattern P13 illustrated in FIG. 10 is data representing a driving signal of which the amplitude is A3 and the frequency is 35 kHz.

When the position of the manipulation input reaches the point E that is the boundary of the manipulation part 121A3, the drive controlling part 240 sets the amplitude value of the amplitude data to zero. In this way, the vibrating element 140A is turned off and the kinetic friction force applied to the fingertip increases. Thereby, the user feels as if the convex portion were present on the surface of the top panel 120. The drive controlling part 240 turns off the vibrating element 140A for the time period TP1.

When the time period TP1 elapses, the drive controlling part 240 drives the vibrating element 140A with the vibration pattern P11 to vibrate the top panel 120A at the frequency in the ultrasound-frequency-band. This is because an area between the point E and the point F is outside of the areas of the manipulation parts 121A2 and 121A3. Accordingly, here, the drive controlling part 240 drives the vibrating element 140A with the vibration pattern P11 that represents the predetermined driving signal.

When the position of the manipulation input reaches the point F and the manipulation input is stopped, the drive controlling part 240 stops driving the vibrating element 140A.

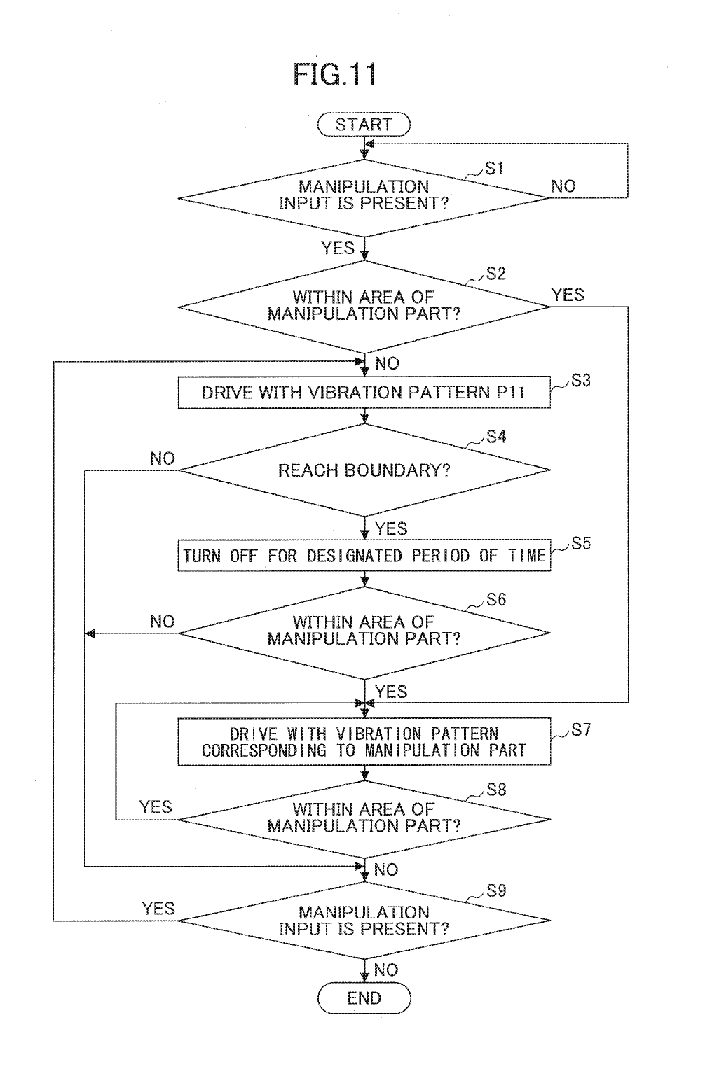

FIG. 11 is a diagram illustrating a flowchart executed by the drive controlling part 240 of the input apparatus 100A according to the working example 1.

First, the drive controlling part 240 determines whether the manipulation input is present (step S1). The drive controlling part 240 may determine presence/absence of the manipulation input based on whether the position data is input from the driver IC 151 (see FIG. 5).

When the drive controlling part 240 determines that the manipulation input is present (yes at step S1), the drive controlling part 240 determines whether the position of the manipulation input is within one of the areas of the manipulation parts 121A1 to 121A4 (step S2). This is because the vibration patterns differ based on whether the position is within one of the areas of the manipulation parts 121A1 to 121A4.

When the drive controlling part 240 determines that the position of the manipulation input is within one of the areas of the manipulation parts 121A1 to 121A4 (yes at step S2), the flow proceeds to step S7. The processing of step S7 will be described later.

When the drive controlling part 240 determines that the position of the manipulation input is not within the areas of the manipulation parts 121A1 to 121A4 (no at step S2), the drive controlling part 240 drives the vibrating element 140A with the vibration pattern P11 (step S3). In this way, the natural vibration in the ultrasound-frequency-band is generated in a part overlapping with the touch panel 150A among the top panel 120A.

The drive controlling part 240 determines whether the position of the manipulation input reaches one of the boundaries of the areas of the manipulation parts 121A1 to 121A4 (step S4). Because the vibrating element 140A is turned off for the time period TP1 when the position enters into one of the areas of the manipulation parts 121A1 to 121A4, it is determined whether the position reaches one of the boundaries of the areas of the manipulation parts 121A1 to 121A4.

When the drive controlling part 240 determines that the position of the manipulation input reaches one of the boundaries of the areas of the manipulation parts 121A1 to 121A4 (yes at step S4), the drive controlling part 240 turns off the vibrating element 140A for the time period TP1 (step S5). This is to provide the feel of the convex portion to the user's fingertip.

Next, the drive controlling part 240 determines whether the position of the manipulation input is within one of the areas of the manipulation parts 121A1 to 121A4 (step S6). This is because the vibration patterns differ based on whether the position is within the areas of the manipulation parts 121A1 to 121A4.

When the drive controlling part 240 determines that the position of the manipulation input is within any of the manipulation parts 121A1 to 121A4 (yes at step S6), the drive controlling part 240 drives the vibrating element 140A with the vibration pattern corresponding to any of the manipulation parts 121A1 to 121A4 (step S7). The drive controlling part 240 may determine the vibration pattern corresponding to any of the manipulation parts 121A1 to 121A4 based on the vibration control data as illustrated in FIG. 6B and the position of the manipulation input.

In a case where the drive controlling part 240 determines that the position is within one of the areas of the manipulation parts 121A1 to 121A4 at step S2, the flow proceeds from step S2 to step S7. Then, the drive controlling part 240 drives the vibrating element 140A with the vibration pattern corresponding to any of the manipulation parts 121A1 to 121A4.

The drive controlling part 240 determines whether the position of the manipulation input is within one of the areas of the manipulation parts 121A1 to 121A4 (step S8). This is because the vibration patterns differ in a case where the position of the manipulation input is outside of the areas of the manipulation parts 121A1 to 121A4.

In a case where the drive controlling part 240 determines that the position of the manipulation input is within one of the areas of the manipulation parts 121A1 to 121A4 (yes at step S8), the flow returns to step S7.

In contrast, in a case where the drive controlling part 240 determines that the position of the manipulation input is not within the areas of the manipulation parts 121A1 to 121A4 (no at step S8), the drive controlling part 240 determines whether the manipulation input is present (step S9). The drive controlling part 240 may determine presence/absence of the manipulation input based on whether the position data is input from the driver IC 151 (see FIG. 5).

When the drive controlling part 240 determines that the manipulation input is present (yes at step S9), the flow returns to step S3 and the drive controlling part 240 drives the vibrating element 140A with the vibration pattern P11.

In contrast, when the drive controlling part 240 determines that the manipulation input is not present (No at step S9), a series of processes ends (END). The drive controlling part 240 does not have to drive the vibrating element 140A in a case where the manipulation input is not present because the user does not perform the manipulation input in this case.

When the drive controlling part 240 determines that the position of the manipulation input does not reach the boundaries of the areas of the manipulation parts 121A1 to 121A4 (no at step S4), the flow proceeds to step S9. This is to determine presence/absence of the manipulation input at step S9. When the manipulation input is present, the flow returns to step S3 and the vibrating element 140A is driven by the vibration pattern P11.

When the drive controlling part 240 determines that the position of the manipulation input is not within the areas of the manipulation parts 121A1 to 121A4 (no at step S6), the flow proceeds to step S9. This is to determine presence/absence of the manipulation input at step S9. When the manipulation input is present, the flow returns to step S3 and the vibrating element 140A is driven by the vibration pattern P11.

Because the kinetic friction force applied to the user's fingertip is varied by generating the natural vibration in the ultrasound-frequency-band of the top panel 120, the input apparatus 100 according to the embodiment can provide the fine tactile sensations to the user.

The vehicular input apparatus 100 of the embodiment has very high convenience because the user can sense manipulation contents with only the tactile sensations when driving the vehicle 10.

For example, in a case where the input apparatus 100A is used as an input part of the navigation device illustrated in FIG. 9, it becomes easy for the user to manipulate the input part because the vibrating element 140A is turned off for the designated time period TP1 and the user feels the convex portion with the fingertip.

For example, as illustrated in FIG. 10, when the user touches the manipulation part 121A2 (PRESENT LOCATION), the manipulation part 121A3 (MENU), and the area except for the manipulation parts 121A2 and 121A3, the vibrating element 140 is driven by using the vibration patterns P11, P12, and P13 different from each other. Thereby, the user can discriminate the manipulation parts 121A2 and 121A3 with the feel of the fingertip.

The input apparatus 100 (see FIGS. 1, 2, and 5) of the embodiment generates the driving signal by causing the amplitude modulator 320 to modulate only the amplitude of the sinusoidal wave in the ultrasound-frequency-band output from the sinusoidal wave generator 310. The frequency of the sinusoidal wave in the ultrasound-frequency-band generated by the sinusoidal wave generator 310 is equal to the natural vibration frequency of the top panel 120. The natural vibration frequency is set in consideration of the vibrating element 140.

The driving signal is generated by causing the amplitude modulator 320 to modulate only the amplitude of the sinusoidal wave in the ultrasound-frequency-band generated by the sinusoidal wave generator 310 without modulating the frequency or the phase of the sinusoidal wave.

Accordingly, it becomes possible to generate the natural vibration of the top panel 120 in the ultrasound-frequency-band in the top panel 120 and to reduce the kinetic friction coefficient applied to the fingertip tracing the top panel 120 with absolute certainty by utilizing the layer of air provided by the squeeze film effect. It becomes possible to provide fine tactile sensations to the user as if the concave portion and the convex portion were present on the surface of the top panel 120 by utilizing the Sticky-band Illusion effect or the Fishbone Tactile Illusion effect.

In the embodiment as described above, in order to provide the tactile sensations to the user as if the concave portions and the convex portions were present on the top panel 120, the vibrating element 140 is switched on or off. Turning off the vibrating element 140 is equal to setting the amplitude value represented by the driving signal used to drive the vibrating element 140 to zero.

However, it is not necessary to turn off the vibrating element 140 from a turned on state. For example, the vibrating element 140 may be driven based on the drive signal having a small amplitude instead of turning off the vibrating element 140. For example, the input apparatus 100 may provide the tactile sensations to the user as if the concave portions and the convex portions were present on the surface of the top panel 120 by reducing the amplitude to about one-fifth of that of the turned on state.

In this case, the vibrating element 140 is driven by the drive signal in a manner that the vibration of the vibrating element 140 is switched between a strong level and a weak level. As a result, the strength of the natural vibration generated in the top panel 120 is switched between the strong level and the weak level. It becomes possible to provide the tactile sensations as if the concave portions and the convex portions were present on the surface of the top panel 120 to the user's fingertip.

If the input apparatus 100 turns off the vibrating element 140 when making the vibration weaker in order to switch the vibration of the vibrating element 140 from the strong level to the weak level, the vibrating element 140 is switched off. Switching on and off the vibrating element 140 means driving the vibrating element 140 intermittently.

According to the embodiment as described above, the input apparatuses 100 and 100A that can provide the fine operational feeling to the user can be provided.

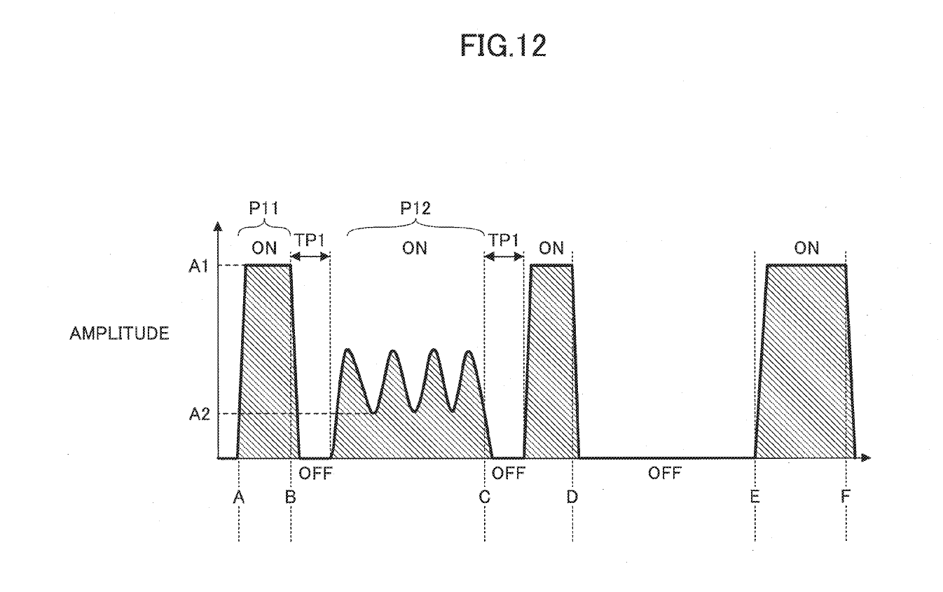

Although the driving patterns using the vibration pattern P13 (see FIG. 10) are used to drive the vibrating element 140A when the manipulation part 121A3 (MENU) is manipulated, the driving patterns as illustrated in FIG. 12 may be used.

FIG. 12 is a diagram illustrating an example of driving patterns of the drive controlling part 240 of the input apparatus 100A according to a variation example of the working example 1. In FIG. 12, the maximum amplitude of the vibration pattern P12 between the point B and the point C corresponding to the manipulation part 121A2 is made smaller than that depicted in FIG. 10, and the vibration between the point D and the point E corresponding to the manipulation part 121A3 is set to zero.

When the maximum amplitude of the manipulation part 121A2 is made smaller than that depicted in FIG. 10, the amplitude changes from the amplitude when the manipulation input is performed in the area except for the manipulation parts 121A2 and 121A3 from the point A to the point B. Thereby, it becomes easy to sense that the position of the manipulation input enters into the area of the manipulation part 121A2.

The amplitude value of the vibration pattern 13 may be set to zero so as to allow the user to recognize a location where the vibration does not occur as the manipulation part 121A3 because the manipulation part 121A3 is a manipulation part for causing the display panel 160 to display the menu screen.

As illustrated in FIG. 8, in the input apparatus 100A of the working example 1, the vibrating element 140A and the touch panel 150A are disposed only in the area having one-quarter of the width of the top panel 120A in x axis direction.

However, for example, in the input apparatus 100 illustrated in FIG. 1, the display panel 160 may display map data and the manipulation parts 121A1, 121A2, 121A3, and 121A4 by GUI components, and the vibrating element 140 may be driven by a vibration pattern corresponding to an area including the position of the manipulation input.

In this case, the manipulation input performed within the area displaying the map data may be detected by the touch panel 150 to perform control (change of a scale of the map data, change of a displaying area or the like) based on the manipulation input.

### WORKING EXAMPLE 2

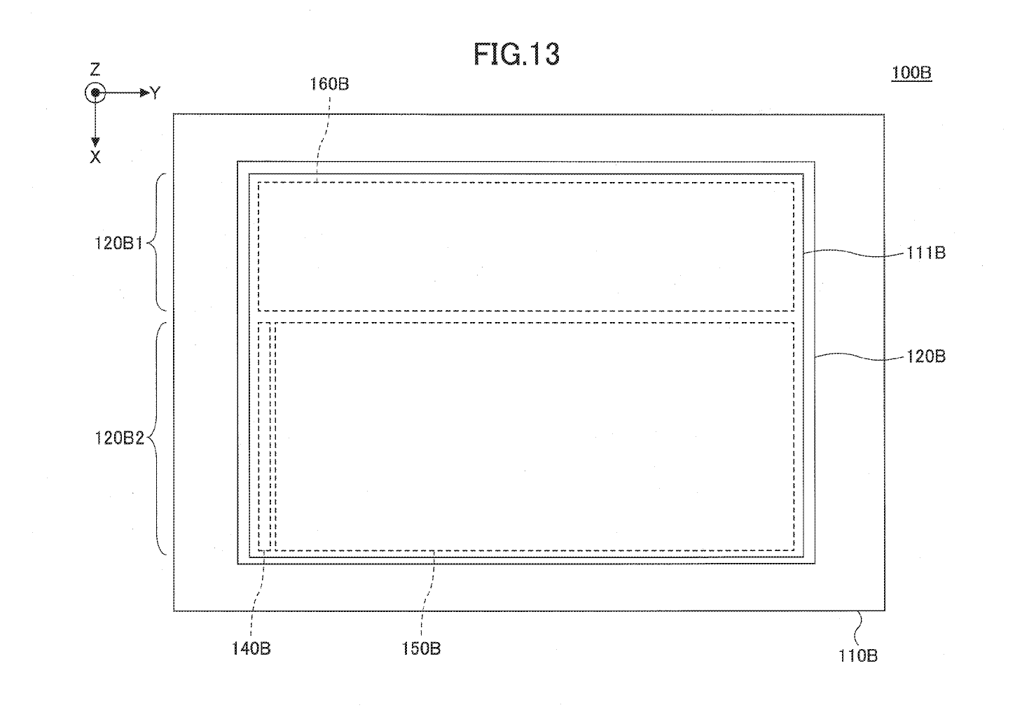

FIG. 13 is a diagram transparently illustrating an internal configuration of an input apparatus 100B of a working example 2 in plan view. The input apparatus 100B of the working example 2 is used as an audio controller, for example. Thus, the input apparatus 100B of the working example 2 is disposed on the center portion 12A of the dashboard 12 in the compartment of the vehicle 10 illustrated in FIG. 7, for example.

The input apparatus 100B includes a housing 110B, a top panel 120B, a vibrating element 140B, a touch panel 150B and a display panel 160B. In FIG. 13, the double-faced adhesive tape 130 and the substrate 170 are omitted.

A concave portion 111B is formed on the housing 110B of the input apparatus 100B illustrated in FIG. 13. The concave portion 111B has a rectangular shape in plan view. Similar to the concave portion 111 of the housing 110 of the embodiment illustrated in FIGS. 1 and 2, the concave portion 111B is formed over the entire housing 110B except for an exterior frame of the housing 110B in plan view.

A display area 120B1 and a manipulation area 120B2 of the top panel 120B are described. The display area 120B1 is an area for displaying the audio controller and the manipulation area 120B2 is an area for manipulating the audio controller. The display area 120B1 is located at a negative side in x axis direction. The manipulation area 120B2 is located at a positive side in x axis direction. A ratio of a length of the display area 120B1 to a length of the manipulation area 120B2 is 2 to 3 in x axis direction, for example.

The vibrating element 140B, the touch panel 150B, and the display panel 160B are disposed inside of the concave portion 111B. The display panel 160B is disposed, inside of the display area 120B1, on the bottom face of the concave portion 111B.

The vibrating element 140B is attached, inside of the manipulation area 120B2, to the back face of the top panel 120B. The touch panel 150B is disposed, inside of the manipulation area 120B2, on the bottom face of the concave portion 111B.

A length of the vibrating element 140B of the input apparatus 100B of the working example 2 in x axis direction is equal to or less than three-fifths of that of the vibrating element 140 of the input apparatus 100 of the embodiment illustrated in FIG. 1.

This is because it is needed to generate, only in a part overlapping with the touch panel 150B located inside of the manipulation area 120B2 among the top panel 120B, a standing wave according to the natural vibration in the ultrasound-frequency-band of the top panel 120B.

Although graphics, characters, and the like representing manipulation parts of the audio controller are printed on the back face of the manipulation area 120B2 of the top panel 120B, the illustration is omitted in FIG. 13.

A double-faced adhesive tape corresponding to the double-faced adhesive tape 130 illustrated in FIGS. 1 and 2 is arranged on an area surrounding the concave portion 111B along an outer periphery of the top panel 120B in plan view. The double-faced adhesive tape bonds the top panel 120B to the housing 110B.

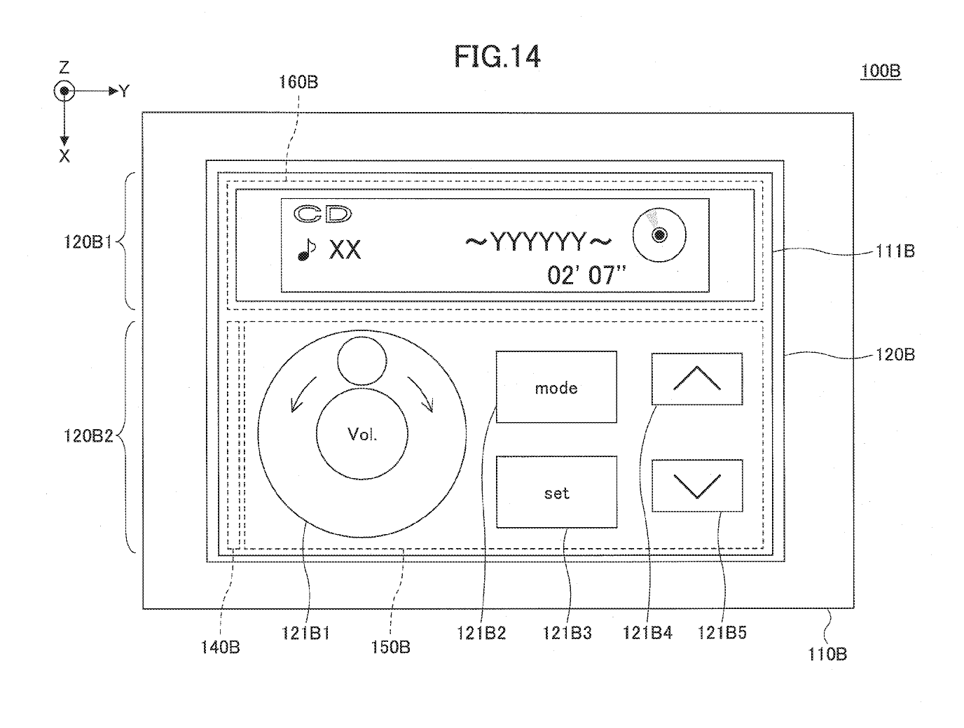

FIG. 14 is a diagram illustrating the input apparatus 100B of the working example 2 in plan view.

As illustrated in FIG. 14, the display panel 160 displays audio status. Manipulation parts 121B1, 121B2, 121B3, 121B4, and 121B5 are disposed in an area that illustrates the touch panel 150B in FIG. 13.

The manipulation parts 121B1, 121B2, 121B3, 121B4, and 121B5 are printed on the back face of the top panel 120B. Although the manipulation parts 121B1, 121B2, 121B3, 121B4, and 121B5 should be seen even in a state where the input apparatus 100 is not operated as illustrated in FIG. 13, they are omitted in FIG. 13 for convenience of the description.

As the area data f1 to f4 illustrated in FIG. 6B, positions in xy coordinate of the five areas, in which the manipulation parts 121B1, 121B2, 121B3, 121B4, and 121B5 are printed, are determined and the five areas are converted into data, respectively. When the manipulation input is performed on the manipulation parts 121B1, 121B2, 121B3, 121B4, and 121B5, the vibrating element 140B is driven by the drive controlling part 240 by using designated vibration patterns for each respective manipulation part 121B.

Such designated vibration patterns may be stored in the memory 250 in association with the area data of the five areas, in which the manipulation parts 121B1, 121B2, 121B3, 121B4, and 121B5 are printed, as the vibration patterns P1 to P4 illustrated in FIG. 6B are associated with the area data f1 to f4.

In a case where the manipulation input is performed, within the area where the touch panel 150B is located in plan view, on a part other than the manipulation parts 121B1, 121B2, 121B3, 121B4, and 121B5, the input apparatus 100B of the working example 2 also causes the drive controlling part 240 to drive the vibrating element 140B.

Thus, among the area where the touch panel 150B is located in plan view, area data representing the area other than the manipulation parts 121B1, 121B2, 121B3, 121B4, and 121B5 may be associated with data representing a vibration pattern as the area data f1 to f4 are associated with the vibration patterns P1 to P4 in the vibration control data illustrated in FIG. 6B.

The manipulation part 121B1 (Vol.) is a dial-type manipulation part for adjusting a sound volume. The manipulation input for turning down the sound volume can be performed by performing a manipulation to rotate the manipulation part 121B1 in a direction of an arrow that represents a counterclockwise direction. The manipulation input for turning up the sound volume can be performed by performing a manipulation to rotate the manipulation part 121B1 in a direction of an arrow that represents a clockwise direction.

The manipulation part 121B2 (mode) is a manipulation part for selecting a mode input state of the audio. The manipulation part 121B3 (set) is a manipulation part for selecting a setting input state of the audio. The manipulation parts 121B4 and 121B5 are manipulation parts used when an option is selected in the mode input state or the setting input state, for example.

When the manipulation input is performed on the surface of the top panel 120B within the five areas where the manipulation parts 121B1, 121B2, 121B3, 121B4, and 121B5 are printed, the position data output from the touch panel 150B is input to the ECU 400. In this way, adjustment of the sound volume, selection of the mode input state, selection of the setting input state, and selection of the option in the mode input state or the setting input state can be performed, respectively.

In the input apparatus 100B of the working example 2, only a part (part corresponding to the manipulation area 120B2) where the vibrating element 140B and the touch panel 150B are present in x axis direction may be treated as an input apparatus. In this case, a part (the display area 120B1) where the display panel 160 is present may be treated as a display part attached to the input apparatus.

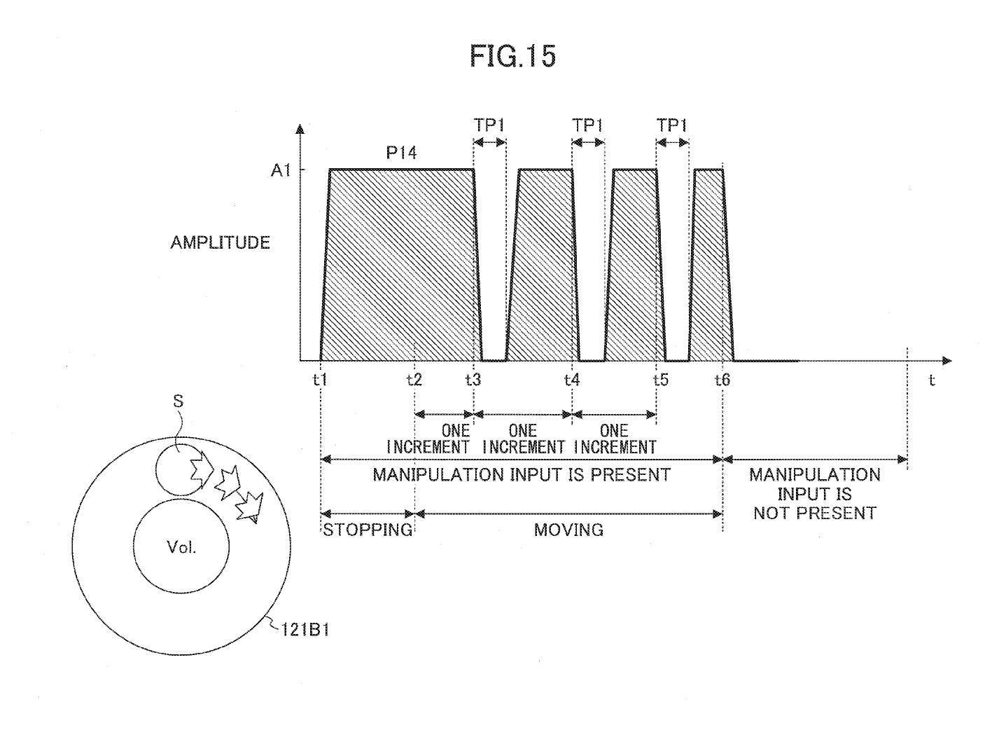

FIG. 15 is a diagram illustrating an example of driving patterns of the drive controlling part 240 of the input apparatus 100B of the working example 2. The drive control by the drive controlling part 240 when the manipulation input is performed on the manipulation parts 121B1, 121B2, 121B3, 121B4, and 121B5 is similar to that of the input apparatus 100A of the working example 1. Here, the drive control by the drive controlling part 240 when the manipulation input is performed on the dial-type manipulation part 121B1 is described.

In FIG. 15, a horizontal axis represents a time axis and a vertical axis represents an amplitude of the driving signal.

At a time t1, the user's fingertip touches a point S illustrated in the manipulation part 121B1 depicted in FIG. 15 and the manipulation input is started. Thereby, the drive controlling part 240 starts to drive the vibrating element 140B. The drive controlling part 240 drives the vibrating element 140B with a vibration pattern P14 to vibrate the top panel 120B at the frequency in the ultrasound-frequency-band.

The vibration pattern P14 represents a driving signal of which the amplitude is A1 and the frequency is 35 kHz. Here, the vibration pattern P14 is data that represents a driving signal used in a case where the manipulation input is performed with the manipulation input part 121B1.

In this way, when the vibrating element 140B is held in the on-state by the vibration pattern P14, the kinetic friction coefficient applied to the user's fingertip is decreased by the squeeze film effect and the fingertip becomes easy to move over the surface of the top panel 120B.

When the position of the manipulation input starts to move at a time t2, the drive controlling part 240 detects a movement amount of the position of the manipulation input from the point S, which is a starting point. At this time, the drive controlling part 240 continuously drives the vibrating element 140B with the vibration pattern P14.

When the movement amount of the position of the manipulation input reaches a manipulation amount of one increment of the dial-type manipulation part 121B1 at a time t3, the drive controlling part 240 turns off the vibrating element 140B for the designated time period TP1. The drive controlling part 240 may turn the vibrating element 140B off by setting the amplitude to zero.

In this way, when the vibrating element 140B is turned off, the natural vibration in the ultrasound-frequency-band of the top panel 120B is turned off. As a result, the kinetic friction force applied to the user's fingertip increases and the user senses a grippy or scratchy touch (texture) with the fingertip. In this case, the user senses as if a convex portion were present on the surface of the top panel 120B when the surface of the top panel 120 becomes grippy and the kinetic friction force increases. Therefore, the user can sense that the manipulation of the manipulation part 121B1 reaches one increment with the fingertip.

The vibrating element 140B is turned off only for the time period TP1. The time period TP1 may be about 50 milliseconds, for example.

When the position of the manipulation input of the user continuously moves after the time period TP1 elapses from the time t3, the drive controlling part 240 drives the vibrating element 140B with the vibration pattern P14 corresponding to the area data of the manipulation part 121B1.

When the movement amount of the position of the manipulation input reaches, from the position of the manipulation input at the time t3, the manipulation amount of one increment of the dial-type manipulation part 121B1 at the time t4, the drive controlling part 240 turns off the vibrating element 140B for the designated time period TP1.

That is, supposing that the position of the manipulation input when the position of the manipulation input reaches a first increment at the time t3 is the starting point, the drive controlling part 240 again monitors the movement amount of the position of the manipulation input. Then, when the movement amount of the position reaches a second increment at the time t4, the drive controlling part 240 turns off the vibrating element 140B.

When the position of the manipulation input of the user continuously moves after the time period TP1 elapses from the time t4, the drive controlling part 240 drives the vibrating element 140B with the vibration pattern P14 corresponding to the area data of the manipulation part 121B1.

When the movement amount of the position of the manipulation input reaches, from the position of the manipulation input at the time t4, the manipulation amount of one increment of the dial-type manipulation part 121B1 at the time t5, the drive controlling part 240 turns off the vibrating element 140B for the designated time period TP1.

That is, supposing that the position of the manipulation input when the position of the manipulation input reaches a second increment at the time t4 is the starting point, the drive controlling part 240 again monitors the movement amount of the position of the manipulation input. Then, when the movement amount of the position reaches a third increment at the time t5, the drive controlling part 240 turns off the vibrating element 140B.

When the position of the manipulation input of the user continuously moves after the time period TP1 elapses from the time t5, the drive controlling part 240 drives the vibrating element 140B with the vibration pattern P14 corresponding to the area data of the manipulation part 121B1.

When the manipulation input is stopped at a time t6, the vibrating element 140 is turned off.

After that, the drive controlling part 240 does not drive the vibrating element 140B because the manipulation input is not performed.

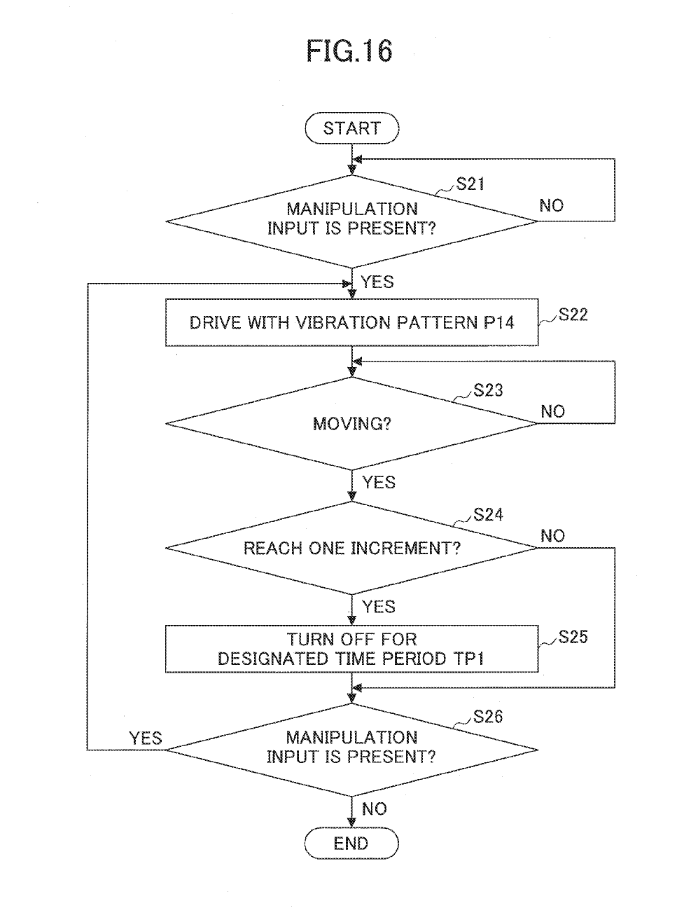

FIG. 16 is a diagram illustrating a flowchart executed by the drive controlling part 240 of the input apparatus 100B according to the working example 2 corresponding to the manipulation of the manipulation part 121B1.

First, the drive controlling part 240 determines whether the manipulation input to the manipulation part 121B1 is present (step S21). The drive controlling part 240 may determine presence/absence of the manipulation input based on whether the position data input from the driver IC 151 (see FIG. 5) is included within the area of the manipulation part 121B1. The drive controlling part 240 repeatedly executes the process of step S21 until the drive controlling part 240 determines that the manipulation input is present.

When the drive controlling part 240 determines that the manipulation input to the manipulation part 121B1 is present (yes at step S21), the drive controlling part 240 drives the vibrating element 140B with the vibration pattern P14 (step S22). In this way, the natural vibration in the ultrasound-frequency-band is generated in the manipulation part 121B1 of the top panel 120B.

The drive controlling part 240 determines whether the position of the manipulation input is moving (step S23). The drive controlling part 240 may determine whether a temporal change of the position of the manipulation input is present to determine whether the position of the manipulation input is moving. The drive controlling part 240 repeatedly executes the process of step S23 until the drive controlling part 240 determines that the position of the manipulation input is moving.

The drive controlling part 240 may store coordinates representing the starting point of the manipulation input. The coordinates representing the starting point of the manipulation input may be stored in the memory 250.

The drive controlling part 240 may determine whether the position of the manipulation input is moving based on the moving speed of the position of the manipulation input. The moving speed may be calculated by a vector operation. A threshold speed may be set as a minimum speed of the moving speed of the fingertip when the user performs the manipulation input on the manipulation part 121B1 while moving the fingertip. Such a minimum speed may be set based on an experimental result, a resolution capability of the touch panel 150 or the like.

The drive controlling part 240 determines whether the movement amount of the position of the manipulation input reaches one increment of the manipulation part 121B1 (step S24).

When the drive controlling part 240 determines that the movement amount of the position of the manipulation input reaches one increment of the manipulation part 121B1 (yes at step S24), the drive controlling part 240 turns off the vibrating element 140B for the time period TP1 (step S25). This is to provide the feel of the convex portion to the user's fingertip.

Next, the drive controlling part 240 determines whether the manipulation input is being performed within the area of the manipulation part 121B1 (step S26). This is to determine whether to perform the drive control in accordance with the manipulation of the manipulation part 121B1.

When the drive controlling part 240 determines that the manipulation input is being performed within the area of the manipulation part 121B1 (yes at step S26), the flow returns to step S22. In this way, the drive controlling part 240 drives the vibrating element 140 with the vibration pattern P14 and continuously performs the processes subsequent to step S23.

When the drive controlling part 240 determines that the manipulation input is not being performed within the area of the manipulation part 121B1 (no at step S26), the series of processes ends (END). The drive controlling part 240 does not have to drive the vibrating element 140B in a case where the manipulation input is not present within the area of the manipulation part 121B1 because the user does not perform the manipulation input on the manipulation part 121B1 in this case.

When the drive controlling part 240 determines that the movement amount of the position of the manipulation input does not reach one increment of the manipulation part 121B1 at step S24, the flow proceeds to step S26. This is because there may be a case where the manipulation input is finished before the movement amount of the position of the manipulation input reaches one increment of the manipulation part 121B1, for example.

Because the kinetic friction force applied to the user's fingertip is varied by generating the natural vibration in the ultrasound-frequency-band of the top panel 120B, the input apparatus 100B according to the working example 2 can provide the fine operational feeling to the user who manipulates the dial-type manipulation part 121B1.

The input apparatus 100B of the working example 2 has very high convenience because the user can sense manipulation contents with the tactile sensations when driving the vehicle 10.

### WORKING EXAMPLE 3

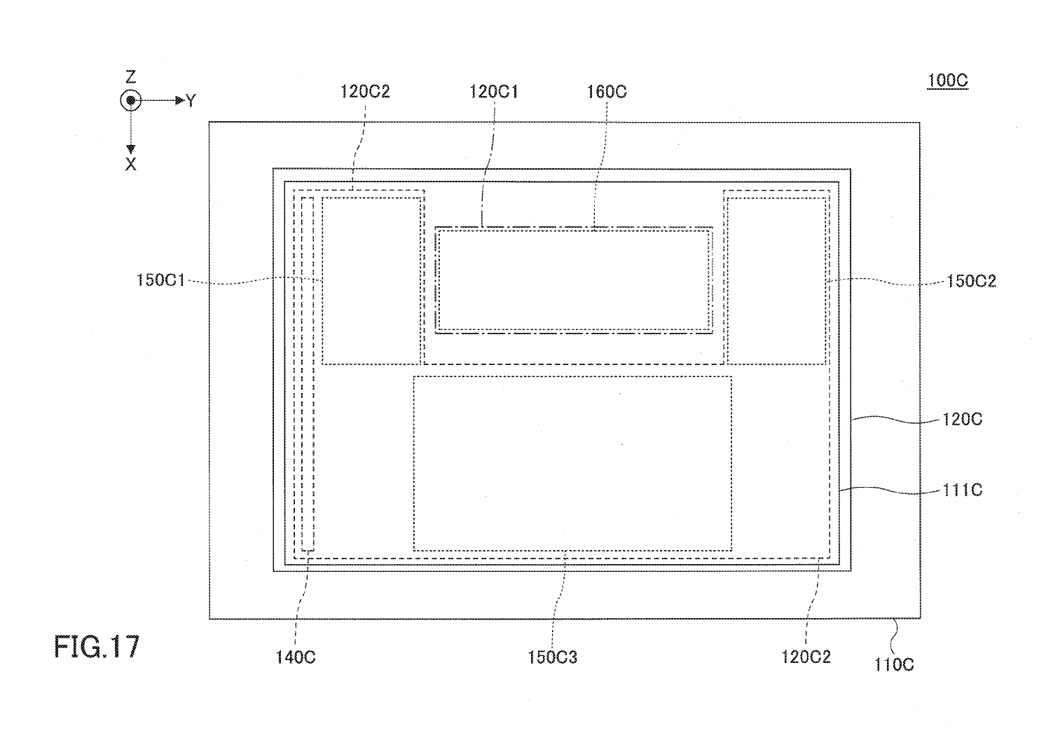

FIG. 17 is a diagram transparently illustrating an internal configuration of an input apparatus 100 C of a working example 3 in plan view. The input apparatus 100C of the working example 3 is used as an air conditioner controller, for example. Thus, the input apparatus 100C of the working example 3 is disposed on the center portion 12A of the dashboard 12 in the compartment of the vehicle 10 illustrated in FIG. 7, for example.

The input apparatus 100C includes a housing 110C, a top panel 120C, a vibrating element 140C, touch panels 150C1, 150C2, and 150C3, and a display panel 160C. In FIG. 17, the double-faced adhesive tape 130 and the substrate 170 are omitted.

A concave portion 111C is formed on the housing 110C of the input apparatus 100C illustrated in FIG. 17. The concave portion 111C has a rectangular shape in plan view. Similar to the concave portion 111 of the housing 110 of the embodiment illustrated in FIGS. 1 and 2, the concave portion 111C is formed over the entire housing 110C except for an exterior frame of the housing 110C in plan view.

A display area 120C1 and a manipulation area 120C2 of the top panel 120C are described. The display area 120C1 is an area for displaying the air conditioner controller and the manipulation area 120C2 is an area for manipulating the air conditioner controller. As illustrated in FIG. 17, the display area 120C1 is located on a center portion in y axis direction at a negative side in x axis direction, and the manipulation area 120C2 is a U-shaped area excluding the display area 120C1 from the rectangular area of the top panel 120C.

The vibrating element 140C, the touch panels 150C1, 150C2, and 150C3, and the display panel 160C are disposed inside of the concave portion 111C. The display panel 160C is disposed, inside of the display area 120C1, on the bottom face of the concave portion 111C.

The vibrating element 140C is attached to the back face of the top panel 120C, along the short side at the negative side in y axis direction inside of the manipulation area 120C2, at a portion over the substantially entire area in x axis direction. As illustrated in FIG. 17, the touch panels 150C1, 150C2, and 150C3 are disposed, inside of the U-shaped manipulation area 120C2, on the bottom face of the concave portion 111C.

A shape of the vibrating element 140C of the input apparatus 100C of the working example 3 is substantially equal to that of the vibrating element 140 of the input apparatus 100 of the embodiment illustrated in FIG. 1 in plan view. However, although the vibrating element 140 of the input apparatus 100 of the embodiment illustrated in FIG. 1 is disposed along the short side at the positive side in y axis direction of the top panel 120, the vibrating element 140C of the input apparatus 100C is disposed along the short side at the negative side in y axis direction of the top panel 120C.

The manipulation area 120C2, where the touch panels 150C1, 150C2, and 150C3 are disposed, has a U-shape in plan view. Thus, in order to generate the standing wave over the entire manipulation area 120C2, it is necessary to generate, over the entire top panel 120C, a standing wave according to the natural vibration in the ultrasound-frequency-band of the top panel 120C.

Although graphics, characters, and the like representing manipulation parts of the air conditioner controller are printed on the back face of the manipulation area 120C2 of the top panel 120C, the illustration is omitted in FIG. 17.

A double-faced adhesive tape corresponding to the double-faced adhesive tape 130 illustrated in FIGS. 1 and 2 is arranged on an area surrounding the concave portion 111C along an outer periphery of the top panel 120C in plan view. The double-faced adhesive tape bonds the top panel 120C to the housing 110C.

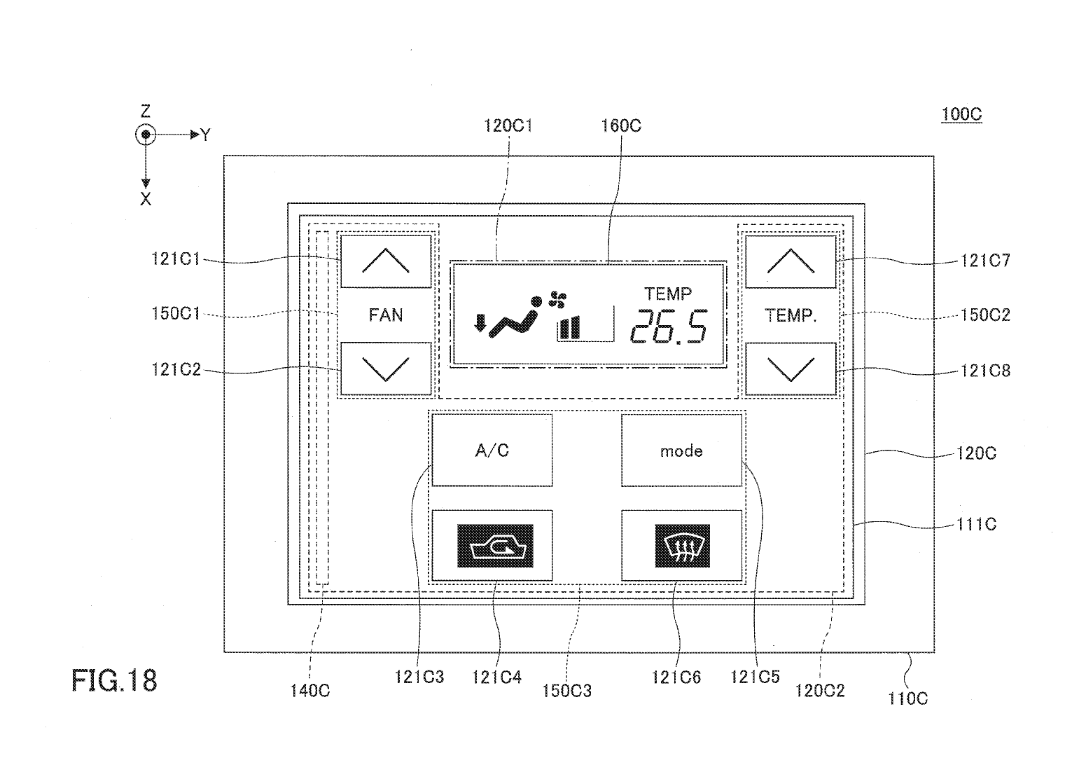

FIG. 18 is a diagram illustrating the input apparatus 100C of the working example 3 in plan view.

Manipulation parts 121C1, 121C2, 121C3, 121C4, 121C5, 121C6, 121C7, and 121C8 are disposed in an area that illustrates the touch panel 150C in FIG. 17.

The manipulation parts 121C1, 121C2, 121C3, 121C4, 121C5, 121C6, 121C7, and 121C8 are printed on the back face of the top panel 120C. Although the manipulation parts 121C1, 121C2, 121C3, 121C4, 121C5, 121C6, 121C7, and 121C8 should be seen even in a state where the input apparatus 100 is not operated as illustrated in FIG. 17, they are omitted in FIG. 17 for convenience of the description.

As the area data f1 to f4 illustrated in FIG. 6, positions in xy coordinate of the eight areas, in which the manipulation parts 121C1, 121C2, 121C3, 121C4, 121C5, 121C6, 121C7, and 121C8 are printed, are determined and the eight areas are converted into data, respectively. When the manipulation input is performed on the manipulation parts 121C1, 121C2, 121C3, 121C4, 121C5, 121C6, 121C7, and 121C8, the vibrating element 140C is driven by the drive controlling part 240 by using designated vibration patterns for each respective manipulation part 121C.

Such designated vibration patterns may be stored in the memory 250 in association with the area data of the eight areas, in which the manipulation parts 121C1, 121C2, 121C3, 121C4, 121C5, 121C6, 121C7, and 121C8 are printed, as the vibration patterns P1 to P4 illustrated in FIG. 6B are associated with the area data f1 to f4.

In a case where the manipulation input is performed, within the area where the touch panel 150C is located in plan view, on a part other than the manipulation parts 121C1, 121C2, 121C3, 121C4, 121C5, 121C6, 121C7, and 121C8, the input apparatus 100C of the working example 3 also causes the drive controlling part 240 to drive the vibrating element 140C.

Thus, among the area where the touch panel 150C is located in plan view, area data representing the area other than the manipulation parts 121C1, 121C2, 121C3, 121C4, 121C5, 121C6, 121C7, and 121C8 may be associated with data representing a vibration pattern as the area data f1 to f4 are associated with the vibration patterns P1 to P4 in the vibration control data illustrated in FIG. 6B.

The manipulation parts 121C1 and 121C2 (FAN) are manipulation parts for adjusting (increasing or decreasing) an fan speed. The manipulation part 121C3 (A/C) is a manipulation part for selecting on/off of the air conditioner. The manipulation part 121C4 is a manipulation part for selecting an interior air circulation mode. The manipulation part 121C5 (mode) is a manipulation part for selecting a mode of the air conditioner. The manipulation part 121C6 is a manipulation part for selecting on/off of a defroster.

The manipulation parts 121C7 and 121C8 (TEMP) are manipulation parts for adjusting (increasing or decreasing) a set temperature of the air conditioner.

When the manipulation input is performed on the surface of the top panel 120C within the eight areas where the manipulation parts121C1, 121C2, 121C3, 121C4, 121C5, 121C6, 121C7, and 121C8 are printed, the position data output from the touch panel 150C is input to the ECU 400. In this way, adjustment of the fan speed, selection of on/off of the air conditioner, selection of the interior air circulation mode, selection of the mode of the air conditioner, selection of on/off of the defroster, and adjustment of the set temperature can be performed, respectively.

In the input apparatus 100C of the working example 3, only a part (part corresponding to the manipulation area 120C2) where the vibrating element 140C and the touch panel 150C are present in x axis direction may be treated as an input apparatus. In this case, a part (the display area 120C1) where the display panel 160 is present may be treated as a display part attached to the input apparatus.

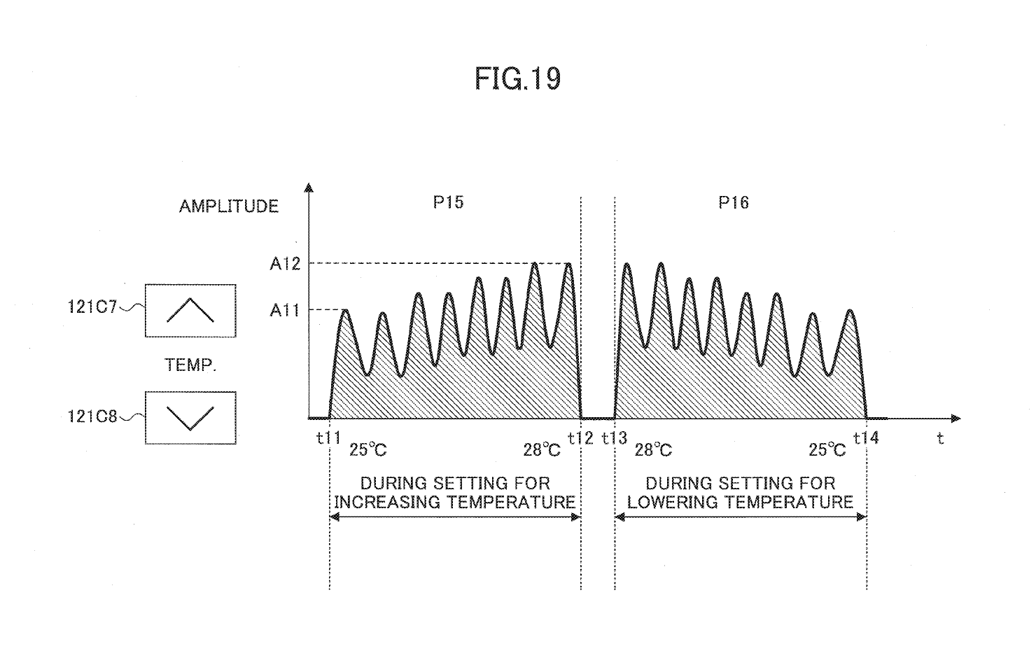

FIG. 19 is a diagram illustrating an example of driving patterns of the drive controlling part 240 of the input apparatus 100C of the working example 3. Here, the drive control by the drive controlling part 240 when the manipulation input is performed to the manipulation parts 121C7 and 121C8 is described, for example.

In FIG. 19, a horizontal axis represents a time axis and a vertical axis represents the amplitude of the driving signal.

At a time tll, the user's fingertip touches the manipulation part 121C7 illustrated in FIG. 19 and the manipulation input is started. Thereby, the drive controlling part 240 starts to drive the vibrating element 140C. The drive controlling part 240 drives the vibrating element 140C with a vibration pattern P15 to vibrate the top panel 120C at the frequency in the ultrasound-frequency-band.

The vibration pattern P15 is data that represents a driving signal obtained by modulating a driving signal of which the frequency is 35 kHz and the amplitude increases in a range from A11 to A12 with a driving signal of which the frequency is 200 Hz. Here, the vibration pattern P15 is data that represents a driving signal used in a case where the manipulation input is performed with the manipulation part 121C7 in order to increase the set temperature.

When the user's fingertip continuously touches the manipulation part 121C7 to perform the manipulation input from a time t11 until a time t12, the drive controlling part 240 continuously drives the vibrating element 140C with the vibration pattern P15 in order to gradually increase the amplitude. When the manipulation input is stopped at the time t12, the drive controlling part 240 stops driving the vibrating element 140.

In this way, when the vibrating element 140C is held in the on-state by the vibration pattern P15, the kinetic friction coefficient applied to the user's fingertip is decreased by the squeeze film effect and the fingertip becomes easy to move over the surface of the top panel 120C.

Because the amplitude gradually increases, the user can sense with the fingertip that the manipulation part 121C7 is manipulated to increase the set temperature.

At a time t13, when the user starts the manipulation input on the manipulation part 121C8, the drive controlling part 240 starts to drive the vibrating element 140C. The drive controlling part 240 drives the vibrating element 140C with a vibration pattern P16 to vibrate the top panel 120C at the frequency in the ultrasound-frequency-band.

The vibration pattern P16 is data that represents a driving signal obtained by modulating a driving signal of which the frequency is 35 kHz and the amplitude decreases in a range from A12 to A11 with a driving signal of which the frequency is 200 Hz. Here, the vibration pattern P16 is data that represents a driving signal used in a case where the manipulation input is performed with the manipulation part 121C8 in order to decrease the set temperature.

When the user's fingertip continuously touches the manipulation part 121C8 to perform the manipulation input from the time t13 until a time t14, the drive controlling part 240 continuously drives the vibrating element 140C with the vibration pattern P16 in order to gradually decrease the amplitude.

In this way, when the vibrating element 140C is held in the on-state by the vibration pattern P16, the kinetic friction coefficient applied to the user's fingertip is decreased by the squeeze film effect and the fingertip becomes easy to move over the surface of the top panel 120C.

Because the amplitude gradually decreases, the user can sense with the fingertip that the manipulation part 121C8 is manipulated to decrease the set temperature.

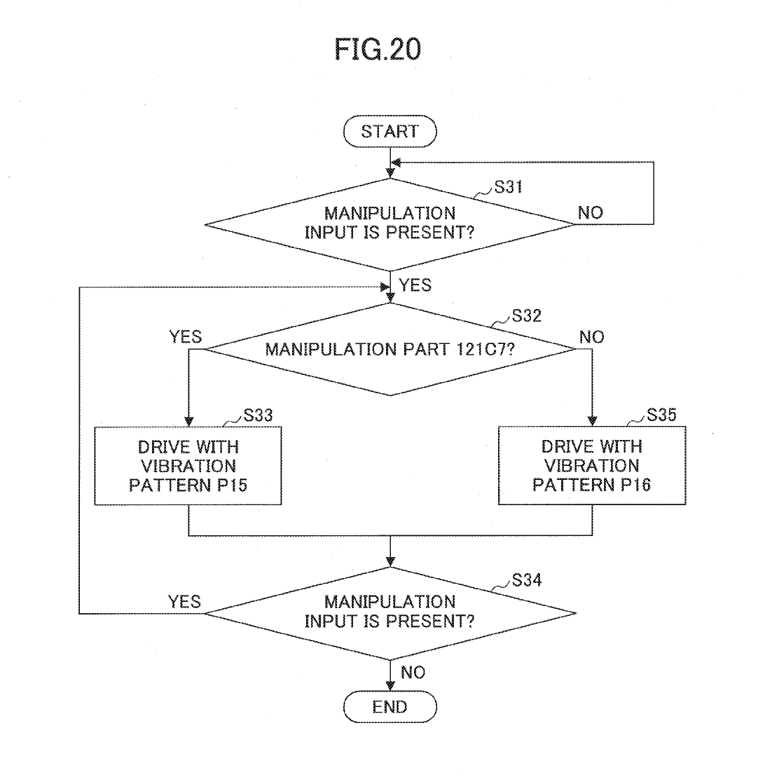

FIG. 20 is a diagram illustrating a flowchart executed by the drive controlling part 240 of the input apparatus 100C according to the working example 3 corresponding to the manipulation of the manipulation part 121C7 or 121C8.

First, the drive controlling part 240 determines whether the manipulation input to the manipulation part 121C7 or 121C8 is present (step S31). The drive controlling part 240 may determine presence/absence of the manipulation input based on whether the position data input from the driver IC 151 (see FIG. 5) is included within the area of the manipulation part 121C7 or 121C8. The drive controlling part 240 repeatedly executes the process of step S31 until the drive controlling part 240 determines that the manipulation input is present.

When the drive controlling part 240 determines that the manipulation input to the manipulation part 121C7 or 121C8 is present (yes at step S31), the drive controlling part 240 determines whether the manipulation input is to the manipulation part 121C7 (step S32).

When the drive controlling part 240 determines that the manipulation input of the manipulation part 121C7 is present (yes at step S32), the drive controlling part 240 drives the vibrating element 140C with the vibration pattern P15 (step S33). In this way, the natural vibration in the ultrasound-frequency-band according to the vibration pattern P15 is generated in the top panel 120C. The natural vibration in the ultrasound-frequency-band according to the vibration pattern P15 is communicated to the user's fingertip in contact with the manipulation part 121C7.

Next, the drive controlling part 240 determines whether the manipulation input to the manipulation part 121C7 or 121C8 is present (step S34). Similar to step S31, the drive controlling part 240 may determine presence/absence of the manipulation input based on whether the position data input from the driver IC 151 (see FIG. 5) is included within the area of the manipulation part 121C7 or 121C8.

When the drive controlling part 240 determines that the manipulation input to the manipulation part 121C7 or 121C8 is present (yes at step S34), the flow returns to step S32.

In contrast, when the drive controlling part 240 determines that the manipulation input to the manipulation part 121C7 or 121C8 is not present (no at step S34) , a series of processes ends (END). The drive controlling part 240 does not have to drive the vibrating element 140C in a case where the manipulation input is not present within the area of the manipulation part 121C7 or 121C8 because the user does not perform the manipulation of the manipulation part 121C7 or 121C8 in this case.

When the drive controlling part 240 determines that the manipulation input to the manipulation part 121C7 is not present (no at step S32), the drive controlling part 240 drives the vibrating element 140C with the vibration pattern P16 (step S35). In this way, the natural vibration in the ultrasound-frequency-band according to the vibration pattern P16 is generated in the top panel 120C. The natural vibration in the ultrasound-frequency-band according to the vibration pattern P16 is communicated to the user's fingertip in contact with the manipulation part 121C8.

Because the kinetic friction force applied to the user's fingertip is varied by generating the natural vibration in the ultrasound-frequency-band of the top panel 120C, the input apparatus 100C according to the working example 3 can provide the fine operational feeling to the user who manipulates the manipulation part 121C7 or 121C8.

The input apparatus 100C of the working example 3 has very high convenience because the user can sense which of the manipulation parts 121C7 and 121C8 is touched based on the increase or the decrease of the amplitude when driving the vehicle 10. The user can sense the manipulation contents with the tactile sensations.

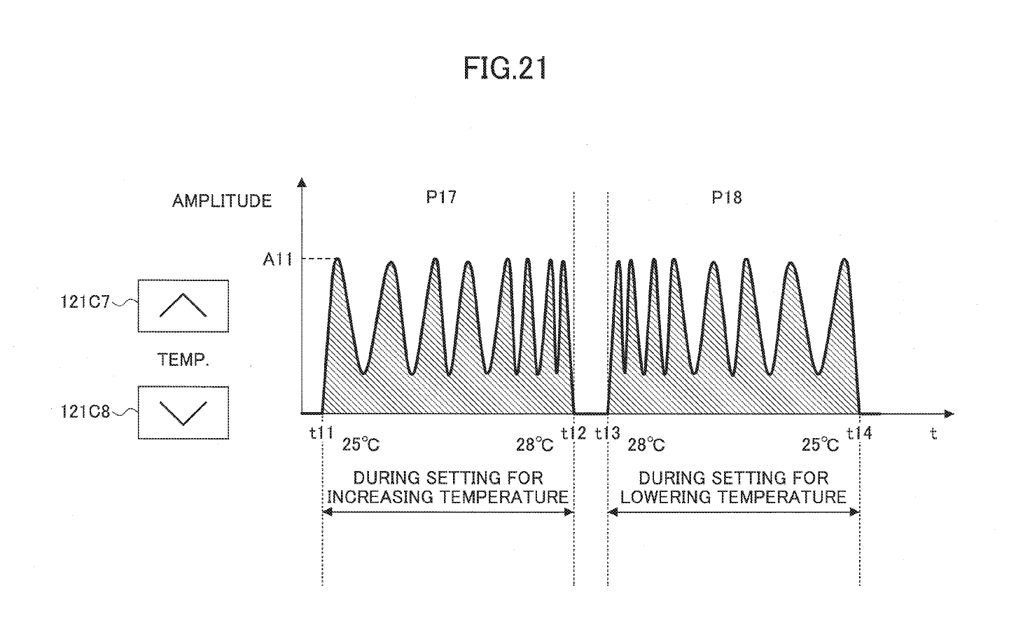

FIG. 21 is a diagram illustrating another example of driving patterns of the drive controlling part 240 of the input apparatus 100C of the working example 3. Here, similar to FIG. 19, the drive control by the drive controlling part 240 when the manipulation input is performed to the manipulation parts 121C7 and 121C8 is described, for example.

In FIG. 19, in a case where the manipulation input is performed with the manipulation part 121C7 in order to increase the set temperature, the vibration pattern P15 of which the amplitude varies in the range from A11 to A12 is used. In FIG. 19, in a case where the manipulation input is performed with the manipulation part 121C8 in order to decrease the set temperature, the vibration pattern P16 of which the amplitude varies in the range from A12 to A11 is used.

In the driving patterns illustrated in FIG. 21, a vibration pattern P17 for increasing the frequency is used in a case where the manipulation input is performed with the manipulation part 121C7 in order to increase the set temperature, and a vibration pattern P18 for decreasing the frequency is used in a case where the manipulation input is performed with the manipulation part 121C8 in order to decrease the set temperature.

The vibration pattern P17 is data that represents a driving signal obtained by modulating a driving signal of which the frequency is 35 kHz and the amplitude is A11 with a driving signal of which the frequency temporally changes from 200 Hz to 400 Hz. The vibration pattern P18 is data that represents a driving signal obtained by modulating the driving signal of which the frequency is 35 kHz and the amplitude is A11 with a driving signal of which the frequency temporally changes from 400 Hz to 200 Hz.

When such a vibration pattern P17 or P18 is used, the user can sense which of the manipulation parts 121C7 and 121C8 is touched based on the increase or the decrease of the frequency when driving the vehicle 10. The user can sense the manipulation contents with the tactile sensations. The position of the manipulation part 121C7 or 121C8 can be sensed by the tactile sensation of the presence of the convex portion. Thus, it is very convenient.

### WORKING EXAMPLE 4

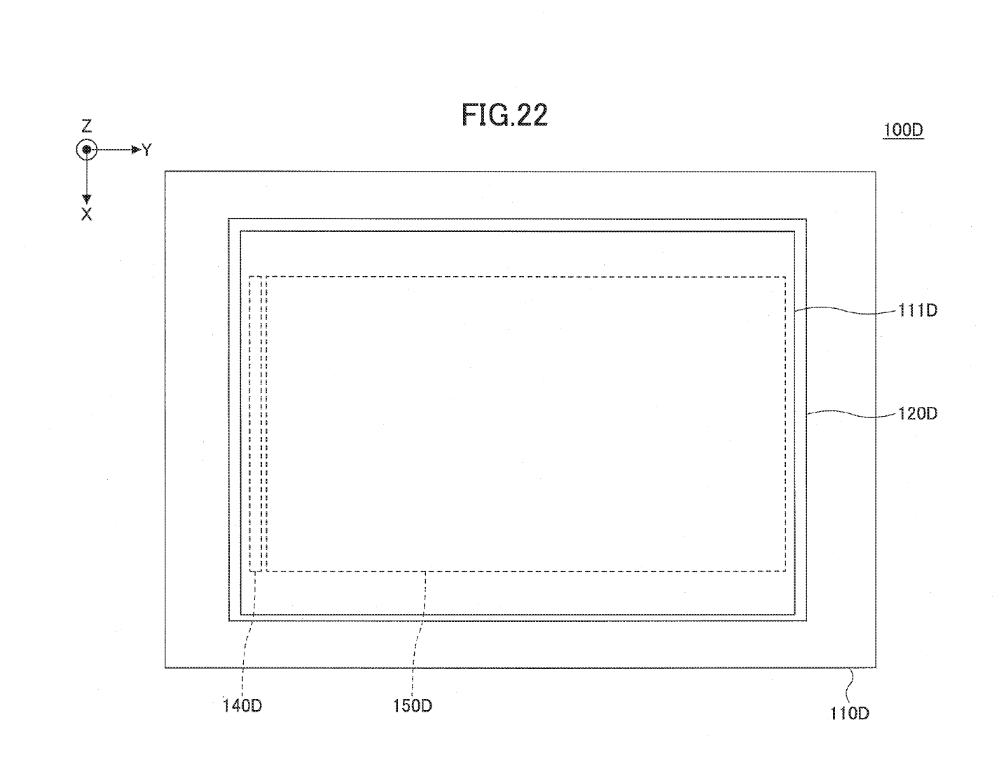

FIG. 22 is a diagram transparently illustrating an internal configuration of an input apparatus 100D of a working example 4 in plan view. The input apparatus 100D of the working example 4 is used as a window controller, for example. Thus, the input apparatus 100D of the working example 4 is disposed on the lining 15 of the door or the like in the compartment of the vehicle 10 illustrated in FIG. 7, for example.

The input apparatus 100D includes a housing 110D, a top panel 120D, a vibrating element 140D, and a touch panel 150D. In FIG. 22, the double-faced adhesive tape 130 and the substrate 170 are omitted. The input apparatus 100D does not include the display panel 160 (see FIG. 1).

A concave portion 111D is formed on the housing 110D of the input apparatus 100D illustrated in FIG. 22. The concave portion 111D has a rectangular shape. Similar to the concave portion 111 of the housing 110 of the embodiment illustrated in FIGS. 1 and 2, the concave portion 111D is formed over the entire housing 110D except for an exterior frame of the housing 110D in plan view.

The vibrating element 140D and the touch panel 150D are disposed inside of the concave portion 111D. The vibrating element 140D is attached to the back face of the top panel 120C, along the short side at the negative side in y axis direction inside of the manipulation area 120C2, at a portion over the substantially entire area in x axis direction. As illustrated in FIG. 22, the touch panel 150D is disposed on the bottom face of the concave portion 111D at a positive side in y axis direction of the vibrating element 140D.

A width of the vibrating element 140D of the input apparatus 100D of the working example 4 in x axis direction is substantially equal to a width of the touch panel 150 in x axis direction.

This is because it is preferable for the vibrating element 140D to have almost the same width in X axis direction as that of the touch panel 150 in order to generate standing waves on the top panel 120D in a whole area in which the touch panel 150D is disposed.

Although graphics, characters, and the like representing manipulation parts of the window controller are printed on the back face of the top panel 120D, the illustration is omitted in FIG. 22.

A double-faced adhesive tape corresponding to the double-faced adhesive tape 130 illustrated in FIGS. 1 and 2 is arranged on an area surrounding the concave portion 111D along an outer periphery of the top panel 120D in plan view. The double-faced adhesive tape bonds the top panel 120D to the housing 110D.

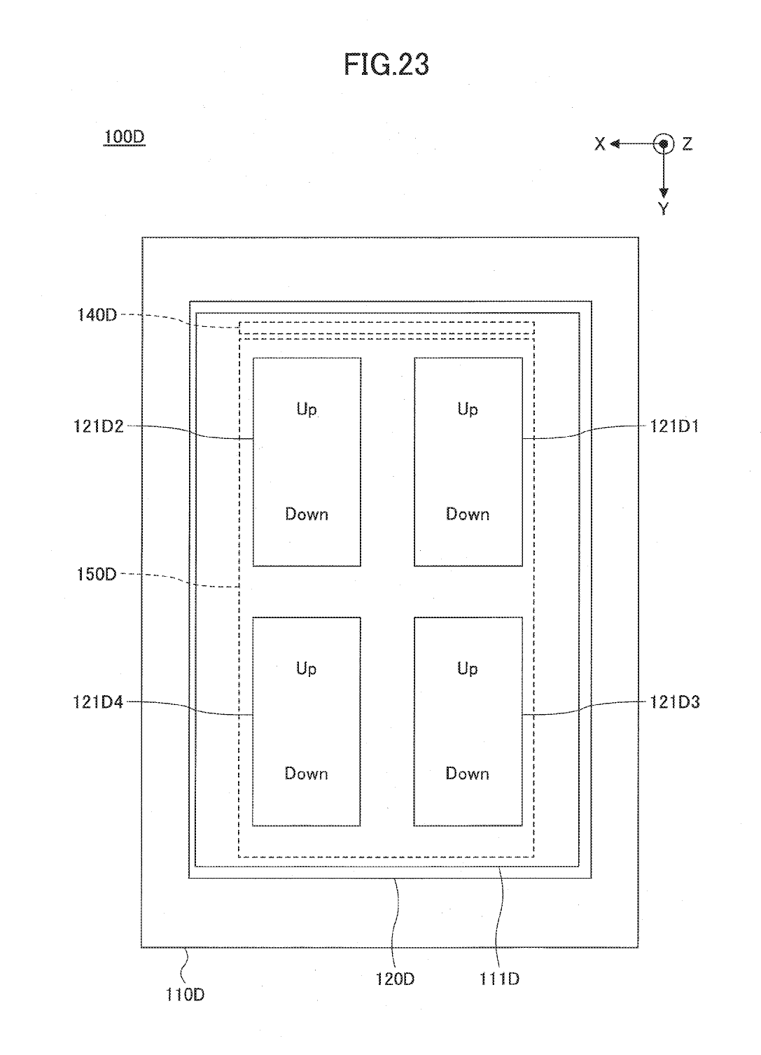

FIG. 23 is a diagram illustrating an operating state of the input apparatus 100D of the working example 4 in plan view.

As illustrated in FIG. 23, manipulation parts 121D1, 121D2, 121D3, and 121D4 are disposed in an area where the touch panel 150D is disposed.

The manipulation parts 121D1, 121D2, 121D3, and 121D4 are printed on the back face of the top panel 120D. Although the manipulation parts 121D1, 121D2, 121D3, and 121D4 should be seen even in a state where the input apparatus 100 is not operated as illustrated in FIG. 22, they are omitted in FIG. 22 for convenience of the description.

As the area data f1 to f4 illustrated in FIG. 6, positions in xy coordinate of the four areas, in which the manipulation parts 121D1, 121D2, 121D3, and 121D4 are printed, are determined and the four areas are converted into data, respectively. When the manipulation input is performed on the manipulation parts 121D1, 121D2, 121D3, and 121D4, the vibrating element 140D is driven by the drive controlling part 240 by using designated vibration patterns for each respective manipulation part 121D.

Such designated vibration patterns may be stored in the memory 250 in association with the area data of the four areas, in which the manipulation parts 121D1, 121D2, 121D3, and 121D4 are printed, as the vibration patterns P1 to P4 illustrated in FIG. 6B are associated with the area data f1 to f4. The vibration patterns P1 to P4 may all be the same.

In a case where the manipulation input is performed, within the area where the touch panel 150D is located in plan view, on a part other than the manipulation parts 121D1, 121D2, 121D3, and 121D4, the input apparatus 100D of the working example 4 may also cause the drive controlling part 240 to drive the vibrating element 140D.

In this case, among the area where the touch panel 150D is located in plan view, area data representing the area other than the manipulation parts 121D1, 121D2, 121D3, and 121D4 may be associated with data representing a vibration pattern as the area data f1 to f4 are associated with the vibration patterns P1 to P4 in the vibration control data illustrated in FIG. 6B.

The manipulation parts 121D, 121D2, 121D3, and 121D4 are manipulation parts for performing opening/closing operation of a window of a front seat right side, a window of a front seat left side, a window of a back seat right side, and a window of a back seat left side, respectively.

When the manipulation input is performed on the surface of the top panel 120D within the four areas where the manipulation parts 121D1, 121D2, 121D3, and 121D4 are printed, the position data output from the touch panel 150D is input to the ECU 400. In this way, the opening/closing operation of the window of the front seat right side, the window of the front seat left side, the window of the back seat right side, and the window of the back seat left side can be performed, respectively.

Because the kinetic friction force applied to the user's fingertip is varied by generating the natural vibration in the ultrasound-frequency-band of the top panel 120D, the input apparatus 100D according to the working example 4 can provide the fine operational feeling to the user who manipulates the manipulation parts 121D1, 121D2, 121D3, and 121D4.

The input apparatus 100D of the working example 4 stops the vibration of the vibrating element 140 at boundary portions of the manipulation parts 121D1, 121D2, 121D3, and 121D4 for a certain period of time. Thereby, the input apparatus 100D has very high convenience because the user can sense the positions of the manipulation parts 121D1, 121D2, 121D3, and 121D4 with the tactile sensation of the presence of the convex portion.

### WORKING EXAMPLE 5

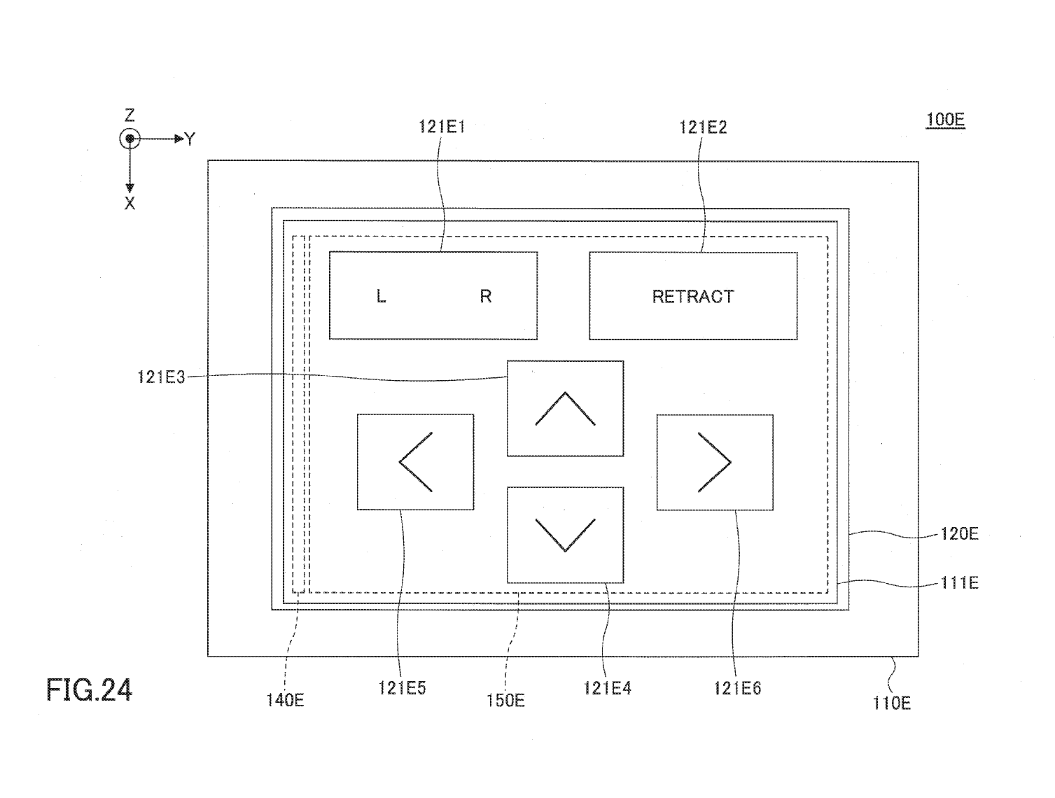

FIG. 24 is a diagram illustrating an operating state of an input apparatus 100E of the working example 5 in plan view. In the input apparatus 100E, a vibrating element 140E and a touch panel 150E, which are similar to the vibrating element 140D and the touch panel 150D of the input apparatus 100D of the working example 4, are disposed inside of a concave portion 111E.

As illustrated in FIG. 24, manipulation parts 121E1, 121E2, 121E3, 121E4, 121E5, and 121E6 are disposed in an area where the touch panel 150E is disposed.

The manipulation parts 121E1, 121E2, 121E3, 121E4, 121E5, and 121E6 are printed on the back face of the top panel 120E. Although the manipulation parts 121E1, 121E2, 121E3, 121E4, 121E5, and 121E6 should be seen even in a state where the input apparatus 100 is not operated as illustrated in FIG. 24, they are omitted in FIG. 24 for convenience of the description.

As the area data f1 to f4 illustrated in FIG. 6, positions in xy coordinate of the six areas, in which the manipulation parts 121E1, 121E2, 121E3, 121E4, 121E5, and 121E6 are printed, are determined and the six areas are converted into data, respectively. When the manipulation input is performed on the manipulation parts 121E1, 121E2, 121E3, 121E4, 121E5, and 121E6, the vibrating element 140E is driven by the drive controlling part 240 by using designated vibration patterns for each respective manipulation part 121E.

Such designated vibration patterns may be stored in the memory 250 in association with the area data of the six areas, in which the manipulation parts 121E1, 121E2, 121E3, 121E4, 121E5, and 121E6 are printed, as the vibration patterns P1 to P4 illustrated in FIG. 6B are associated with the area data f1 to f4. The vibration patterns P1 to P4 may all be the same.

The manipulation part 121E1 is a manipulation part for selecting right and left outer mirrors. The manipulation part 121E2 is a manipulation part for retracting the outer mirror. The manipulation parts 121E3, 121E4, 121E5, 121E6 are manipulation parts for moving the mirror surface of the outer mirror upward, downward, leftward, rightward, respectively.

Other configurations are similar to those of the input apparatus 100D of the working example 4.

Because the kinetic friction force applied to the user's fingertip is varied by generating the natural vibration in the ultrasound-frequency-band of the top panel 120E, the input apparatus 100E according to the working example 5 can provide the fine operational feeling to the user who manipulates the manipulation parts 121E1, 121E2, 121E3, 121E4, 121E5, and 121E6.

The input apparatus 100E of the working example 5 stops the vibration of the vibrating element 140 at boundary portions of the manipulation parts 121E1, 121E2, 121E3, 121E4, 121E5, and 121E6 for a certain period of time. Thereby, the input apparatus 100E has very high convenience because the user can sense the positions of the manipulation parts 121E1, 121E2, 121E3, 121E4, 121E5, and 121E6 with the tactile sensation of the presence of the convex portion.

### WORKING EXAMPLE 6

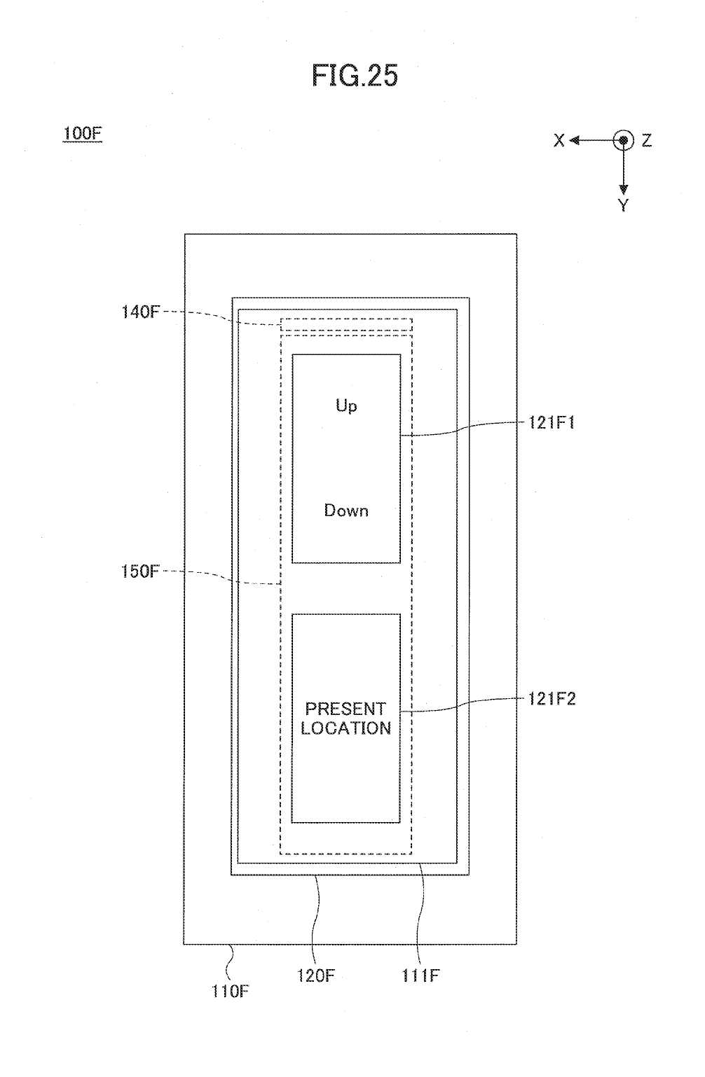

FIG. 25 is a diagram illustrating an operating state of an input apparatus 100F of the working example 6 in plan view.

The input apparatus 100F is disposed on the spoke portion 13A of the steering wheel 13 illustrated in FIG. 7, for example. The user can perform the manipulation input on the input apparatus 100F while driving the vehicle 10.

In the input apparatus 100F, a vibrating element 140F and a touch panel 150F, which are similar to the vibrating element 140D and the touch panel 150D of the input apparatus 100D of the working example 4, are disposed inside of a concave portion 111F of a housing 110F.

As illustrated in FIG. 25, manipulation parts 121F1 and 121F2 are disposed in an area where the touch panel 150F is disposed.

The manipulation parts 121F1 and 121F2 are printed on the back face of the top panel 120F.

The manipulation part 121F1 is a manipulation part for increasing or decreasing an audio volume or the like. The manipulation part 121F2 is a manipulation part for displaying the present location in the navigation device.

Other configurations are similar to those of the input apparatus 100D of the working example 4 or the input apparatus 100E of the working example 5.

Because the kinetic friction force applied to the user's fingertip is varied by generating the natural vibration in the ultrasound-frequency-band of the top panel 120F, the input apparatus 100F according to the working example 6 can provide the fine operational feeling to the user who manipulates the manipulation part 121F1 and 121F2.

The input apparatus 100F of the working example 6 stops the vibration of the vibrating element 140 at boundary portions of the manipulation parts 121F1 and 121F2 for a certain period of time. Thereby, the user can sense the positions of the manipulation parts 121F1 and 121F2 with the tactile sensation of the presence of the convex portion.

The input apparatus 100F has very high convenience because the user of the vehicle 10 can perform the manipulation input while driving the vehicle 10 without releasing the hands from the steering wheel 13.

### WORKING EXAMPLE 7

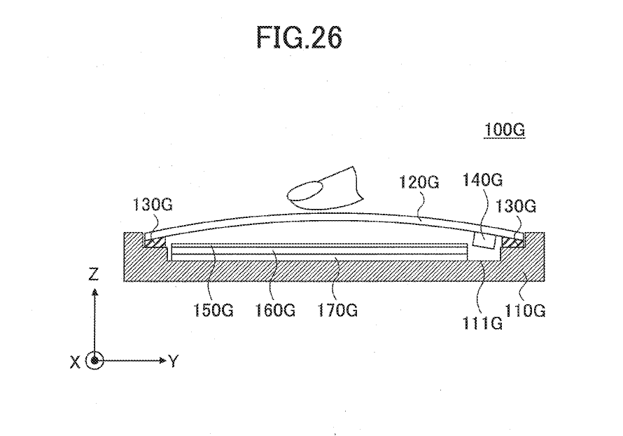

FIG. 26 is a diagram illustrating an operating state of an input apparatus 100G of the working example 7 in plan view.

The input apparatus 100G includes a housing 110G, a top panel 120G, a double-faced adhesive tape 130G, a vibrating element 140G, a touch panel 150G, a display panel 160G, and a substrate 170G.

The input apparatus 100G illustrated in FIG. 26 has a configuration similar to that of the input apparatus 100 of the embodiment illustrated in FIG. 2 except for the top panel 120G being a curved glass.

The top panel 120G is curved so that its center portion in plan view protrudes towards a positive side in z axis direction. Although FIG. 26 illustrates a cross-section shape of the top panel 120G in a YZ plane, a cross-section shape in a XZ plane is similar to the cross-section shape in the YZ plane.

As described above, by using the top panel 120G of the curved glass and by matching the curved surface of the top panel 120G to various parts inside or outside of the vehicle 10, the input apparatus 100G, which is easy to be disposed inside or outside of the vehicle 10 in design, can be provided in addition to the fine operational feeling.

Although an input apparatus according to the embodiments of the present invention has been described, the present invention is not limited to the embodiments specifically disclosed and various variations and modifications may be made without departing from the scope of the present invention.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the sprit and scope of the invention.

What is claimed is:

1. An input apparatus mountable on a vehicle, the input apparatus comprising:
a touch panel connectable to a control unit mounted on the vehicle and configured to output a signal in accordance with a manipulation input performed on a manipulation input surface;
a vibrating element configured to generate a vibration in the manipulation input surface; and
a drive controlling part configured to drive the vibrating element by using a driving signal causing the vibrating element to generate a natural vibration in an ultrasound-frequency-band in the manipulation input surface.

2. The input apparatus as claimed in claim 1, wherein the drive controlling part drives the vibrating element so as to vary an intensity of the natural vibration in accordance with a position of the manipulation input performed on the manipulation input surface and a temporal change degree of the position.

3. The input apparatus as claimed in claim 1, wherein a printed portion that represents a manipulation area in which the manipulation input to the control unit is performed, a concave-convex portion that represents the manipulation area, or a display part that displays the manipulation area by light illumination is formed on the manipulation input surface.

4. The input apparatus as claimed in claim 1, further comprising:
a top panel configured to cover a surface of the touch panel;
wherein the manipulation input surface is a surface of the top panel, and
wherein a printed portion that represents a manipulation area in which the manipulation input to the control unit is performed, a concave-convex portion that represents the manipulation area, or a display part that displays the manipulation area by light illumination is formed on the top panel.

5. The input apparatus as claimed in claim 1 further comprising:
a display part disposed on a back face side of the touch panel.

6. The input apparatus as claimed in claim 5, wherein the display part displays, on the manipulation input surface, a GUI input part representing a manipulation area in which the manipulation input to the control unit is performed.

7. The input apparatus as claimed in claim 3, wherein, in a case where the manipulation input is performed inside of the manipulation area, the drive controlling part drives the vibrating element by using the driving signal that causes a modulated vibration to occur, the modulated vibration being obtained by modulating the natural vibration in the ultrasound-frequency-band with a vibration of a designated pattern in an audible frequency band.

8. The input apparatus as claimed in claim 3, wherein, in a case where the manipulation input performed inside of the manipulation area represents an increase or decrease of a setting degree to the control unit, the drive controlling part drives the vibrating element so as to increase or decrease an intensity of the natural vibration.

9. The input apparatus as claimed in claim 7, wherein, in a case where the manipulation input performed inside of the manipulation area represents an increase or decrease of a setting degree to the control unit, the drive controlling part drives the vibrating element so as to increase or decrease a frequency of the vibration of the designated pattern.

10. The input apparatus as claimed in claim 3, wherein the drive controlling part drives the vibrating element so as to vary an intensity of the natural vibration when a manipulation amount of the manipulation input in the manipulation area reaches a unit manipulation amount.

11. The input apparatus as claimed in claim 3, wherein the drive controlling part drives the vibrating element so as to vary an intensity of the natural vibration when a position of the manipulation input moves across a boundary of the manipulation area or moves while the manipulation area is being manipulated.
